(19) United States
(12) Patent Application Publication
(10) Pub. No.: US 2006/0075362 A1
(43) Pub. Date: Apr. 6, 2006

(54) Image processing apparatus, method, and recording medium on which program is recorded for displaying thumbnail/preview image

(76) Inventors: Kiyotaka Moteki, Tokyo (JP); Osamu Kizaki, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/234,320

(22) Filed: Sep. 26, 2005

(30) Foreign Application Priority Data
Oct. 1, 2004 (JP) 2004-290325
Oct. 5, 2004 (JP) 2004-292810

(51) Int. Cl. G06F 3/00

(52) U.S. Cl. 715/838

(57) ABSTRACT

An image processing apparatus is disclosed that includes a display part, an image data storage part for storing original image data corresponding to an original image, a thumbnail image data generating part for generating thumbnail image data based on the original image data of the original image, a transferring part for transferring the generated thumbnail image data to the display part, and a determining part for determining whether the thumbnail image data is to be transferred to the display part. When the determining part determines that the thumbnail image data is not to be transferred to the display part, the display part withholds from displaying an original thumbnail image corresponding to the generated thumbnail image data and displays a replacement thumbnail image indicating that the display of the original thumbnail image is withheld.

### BACKGROUND OF THE INVENTION

1. Field of the Invention

The present invention relates to an image processing apparatus for displaying a thumbnail, a method for displaying a thumbnail, a recording medium on which a program for displaying a thumbnail is recorded, an image processing apparatus for displaying a preview image, a method for displaying a preview image, and a recording medium on which a program for displaying a preview image is recorded.

2. Description of the Related Art

Thumbnails are, for example, used for confirming the content of image data. A thumbnail is displayed on a screen (display) by, for example, reducing the resolution of the image corresponding to the thumbnail, in order to fit the thumbnail within the frame of a predetermined size. Since thumbnails allow the content of multiple images to be easily recognized, many applications and operating systems (OS) employ thumbnails. Some apparatuses (e.g., a multi-function apparatus) display thumbnails on screens of their respective control parts.

However, thumbnails, in most cases, are employed for displaying multiple images rather than displaying a single image. Therefore, the procedure of displaying the thumbnails generates a large workload for the CPU. Since a large size image, particularly, has a large data size, a large amount of time is required for transferring its image data and for generating corresponding thumbnail image data (image data dedicated for generating its thumbnail). Furthermore, the data of such images occupy a large amount of space in the memory such as VRAM.

Therefore, the displaying of thumbnails consumes a large amount of resources (e.g. hardware resources) and increases the workload of the image processing apparatus (e.g. copier). This adversely affects the primary operations (e.g. copying, printing) of the image forming apparatus.

Similarly, preview images are also, for example, used for confirming the content of image data. A preview image is displayed on a screen (display) by, for example, reducing the resolution of the original image corresponding to the preview image in order to fit the preview image within the frame of a predetermined size. Since a preview image allows the content of an original image to be easily recognized, many applications and operating systems (OS) employ preview images. Some apparatuses (e.g. a multi-function apparatus) display preview images on screens of their respective control parts.

However, since the scale (reduction ratio) becomes considerably small when forming a preview image of a large size image (e.g. drawings), the benefit obtained by forming preview images (e.g. easily recognizing the content of an image) cannot be satisfactorily attained. Furthermore, in a case of an image including letters, the letters become difficult to distinguish when a preview image of the image is formed.

### SUMMARY OF THE INVENTION

It is a general object of the present invention to provide an image processing apparatus, a method, and a recording medium that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an image processing apparatus, a method, and a recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides an image processing apparatus including: a display part; an image data storage part for storing original image data corresponding to an original image; a thumbnail image data generating part for generating thumbnail image data based on the original image data of the original image; a transferring part for transferring the generated thumbnail image data to the display part; and a determining part for determining whether the thumbnail image data is to be transferred to the display part; wherein when the determining part determines that the thumbnail image data is not to be transferred to the display part, the display part withholds displaying an original thumbnail image corresponding to the generated thumbnail image data and displays a replacement thumbnail image indicating that the display of the original thumbnail image is withheld.

Furthermore, the present invention provides a thumbnail display method including the steps of: a) determining whether to display an entire image of an original image as a thumbnail image; b) withholding displaying the entire image of the original image as the thumbnail image when determining not to display the entire image of the original image in step a); and c) displaying a replacement thumbnail image indicating that the display of the entire image of the original image is withheld.

Furthermore, the present invention provides a recording medium on which a program for causing an image processing apparatus to execute a thumbnail display method is recorded, the thumbnail display method including the steps of: a) determining whether to display an entire image of an original image as a thumbnail image; b) withholding displaying the entire image of the original image as the thumbnail image when determining not to display the entire image of the original image in step a); and c) displaying a replacement thumbnail image indicating that the display of the entire image of the original image is withheld.

Furthermore, the present invention provides an image processing apparatus for displaying a preview image of an original image, the image processing apparatus including: a preview area setting part for setting the area for displaying the preview image; and a display part for displaying the preview image in correspondence with the area set by the preview area setting part.

Furthermore, the present invention provides a preview display method for displaying a preview image of an original image, the method including the steps of: a) setting the area for displaying the preview image; and b) displaying the preview image in correspondence with the area set in step a).

Furthermore, the present invention provides a recording medium on which a program for causing an image processing apparatus to execute a preview display method is recorded, the preview display method including the steps of: a) setting the area for displaying the preview image; and b) displaying the preview image in correspondence with the area set in step a).

Other objects and further features of the present invention will be apparent from the following detailed description when read in conjunction with the accompanying drawings.

### BRIEF DESCRIPTION OF THE DRAWINGS

FIG. 1 is a schematic diagram showing a screen displaying thumbnails (thumbnails images) including a replacement thumbnail image according to the first embodiment of the present invention;

FIG. 2 is a schematic diagram showing a screen displaying thumbnails in a case where withholding the displaying of an original thumbnail image is canceled according to the first embodiment of the present invention;

FIG. 3 is a block diagram showing a software configuration of an image processing apparatus according to the first embodiment of the present invention;

FIG. 4 is a block diagram showing a hardware configuration of an image processing apparatus according to the first embodiment of the present invention;

FIG. 5 is a schematic diagram showing the flow of image data according to the first embodiment of the present invention;

FIG. 6 is a schematic diagram showing a screen for allowing the user to set a partial image according to the first embodiment of the present invention;

FIG. 7 is a schematic diagram showing an entire image and a partial image according to the first embodiment of the present invention;

FIG. 8 is a schematic diagram showing a screen displaying thumbnail images including a thumbnail image of a partial image according to the first embodiment of the present invention;

FIG. 9 is a flowchart showing a process for displaying a thumbnail image(s) according to the first embodiment of the present invention;

FIG. 10 is a flowchart showing a process for determining whether it is possible to display a thumbnail image of an entire image according to the first embodiment of the present invention;

FIG. 11 is a flowchart showing a process for transferring image data of an entire image according to the first embodiment of the present invention;

FIG. 12 is a flowchart showing a process for transferring image data of a partial image according to the first embodiment of the present invention;

FIG. 13 is a flowchart showing a process for selecting a replacement thumbnail image and displaying a thumbnail image of a partial image;

FIG. 14 is a schematic diagram showing an example of a large image having a large size;

FIG. 15 is a schematic diagram showing a partial image area setting screen and a preview display screen according to the second embodiment of the present invention;

FIG. 16 is a block diagram showing a software configuration of an image processing apparatus according to the second embodiment of the present invention;

FIG. 17 is a block diagram showing a hardware configuration of an image processing apparatus according to the second embodiment of the present invention;

FIG. 18 is a schematic diagram showing the flow of image data according to the second embodiment of the present invention;

FIG. 19 is a schematic diagram showing preview display area setting screen according to the second embodiment of the present invention;

FIG. 20 is a schematic diagram showing a partial image area setting screen (Part 1) according to the second embodiment of the present invention;

FIG. 21 is a schematic diagram showing a partial image area setting screen (Part 2) according to the second embodiment of the present invention;

FIG. 22 is a schematic diagram showing a partial image area setting screen (Part 3) according to the second embodiment of the present invention;

FIG. 23 is a schematic diagram showing a preview display area setting screen (Part 1) according to the second embodiment of the present invention;

FIG. 24 is a schematic diagram showing an attribute input screen according to the second embodiment of the present invention;

FIG. 25 is a schematic diagram showing a preview display area setting screen (Part 2) according to the second embodiment of the present invention;

FIG. 26 is a schematic diagram showing a preview display area setting screen (Part 3) according to the second embodiment of the present invention;

FIG. 27 is a schematic diagram showing a partial image area setting screen according to the second embodiment of the present invention;

FIG. 28 is a schematic diagram showing an image table screen (Part 1) according to the second embodiment of the present invention;

FIG. 29 is a schematic diagram showing an image attribute setting screen according to the second embodiment of the present invention;

FIG. 30 is a schematic diagram showing an image table screen (Part 2) according to the second embodiment of the present invention;

FIG. 31 is a flowchart showing a process for displaying a preview image(s) according to the second embodiment of the present invention;

FIG. 32 is a flowchart showing a process for determining whether it is possible to display a preview image of an entire image according to the second embodiment of the present invention;

FIG. 33 is a flowchart showing a process for transferring image data of an entire image according to the second embodiment of the present invention; and

FIG. 34 is a flowchart showing a process for transferring image data of a partial image according to the second embodiment of the present invention.

### DESCRIPTION OF THE PREFERRED EMBODIMENTS

In the following, embodiments of the present invention are described with reference to the accompanying drawings.

### First Embodiment

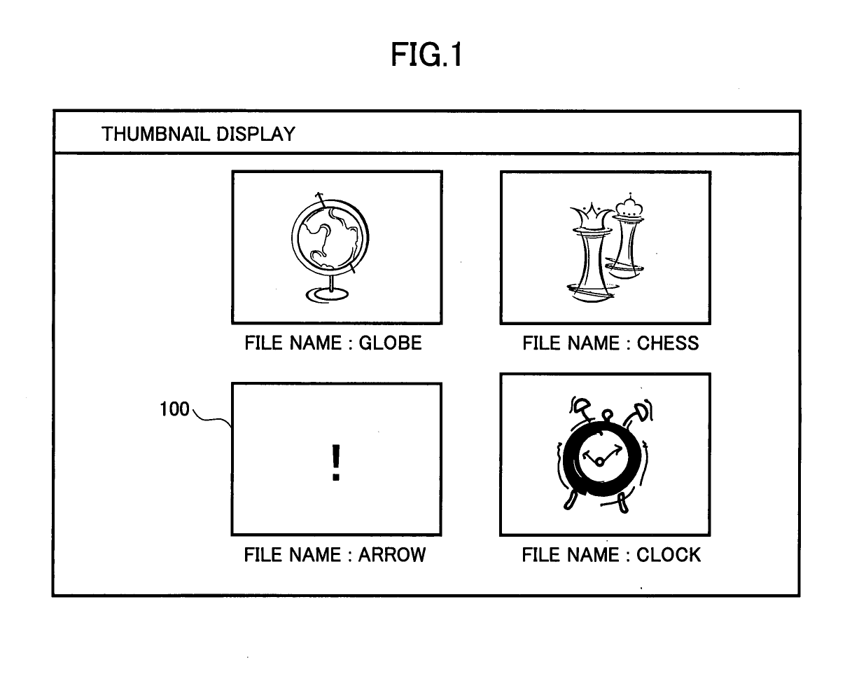

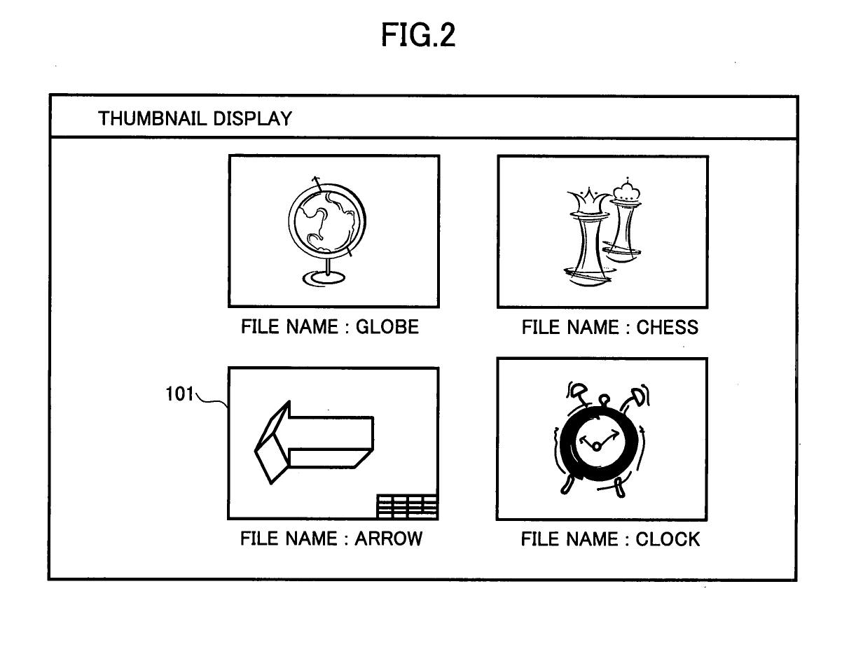

FIG. 1 shows a screen displaying thumbnails including three thumbnail images and one replacement thumbnail image. The image illustrated with an exclamation mark and denoted with reference numeral 100 is a replacement thumbnail image indicating that the thumbnail image which is supposed to be displayed (i.e. original thumbnail image indicated with reference numeral 101 in FIG. 2) is withheld from being displayed. The name of the file corresponding to the original thumbnail image is indicated below the replacement thumbnail image 100.

The original thumbnail image, which is withheld from being displayed, is an image that consumes a large amount of resources (e.g. a large size image). In order to display the original thumbnail image, a user may cancel withholding the display of the original thumbnail image by selecting the replacement thumbnail image 100 with a mouse (not shown), for example. By canceling the withholding of the display of the original thumbnail image, the original thumbnail image 101 can be displayed as shown in FIG. 2.

Accordingly, by withholding the display of an image having a large data size, the workload of an image processing apparatus can be reduced.

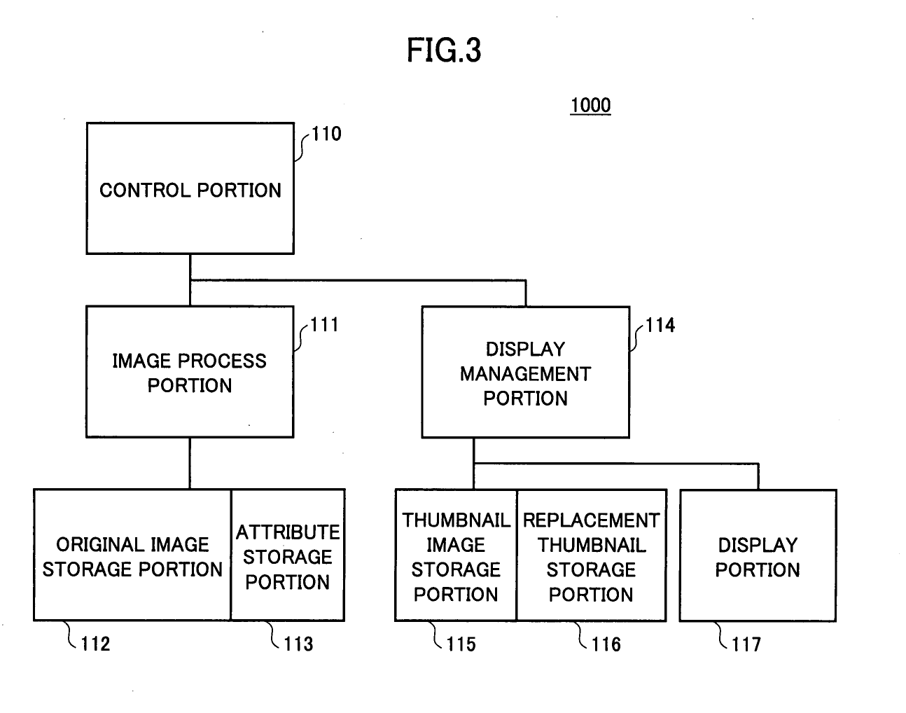

Next, an image processing apparatus 1000 according to an embodiment of the present invention is described. FIG. 3 is a block diagram showing a software configuration of the image processing apparatus 1000 according to a first embodiment of the present invention. FIG. 3 shows a control portion 110, an image process portion 111, an original image storage portion 112, an attribute storage portion 113, a display management portion 114, a thumbnail image storage portion 115, a replacement thumbnail image storage portion 116, and a display portion 117.

The control portion 110 performs the overall control of the image processing apparatus 1000. The image process portion 111 performs various processes on image data (e.g., compression of image data of various images, generation of image data of various images). The image process portion 111, for example, generates thumbnail image data in correspondence with original image data. The original image storage portion 112 stores original image data. The attribute storage portion 113 stores attribute data corresponding to the original image data. The display management portion 114 manages the displaying of the thumbnail images. The thumbnail image storage portion 115 stores thumbnail image data. The replacement thumbnail image storage portion 116 stores replacement thumbnail image data (e.g., data of the replacement thumbnail image 100 shown in FIG. 1). The display portion 117 displays images including, for example, original images (entire images), original thumbnail images (partial images), and replacement thumbnail images.

It is to be noted that the control portion 110 corresponds to a determining part. The image process portion 111 corresponds to a transferring part and a generating part. The original image storage portion 112 corresponds to an original image storage part. The display management portion 114 and the display portion 117 correspond to a displaying part. The thumbnail image storage portion 115 corresponds to a thumbnail image storage part.

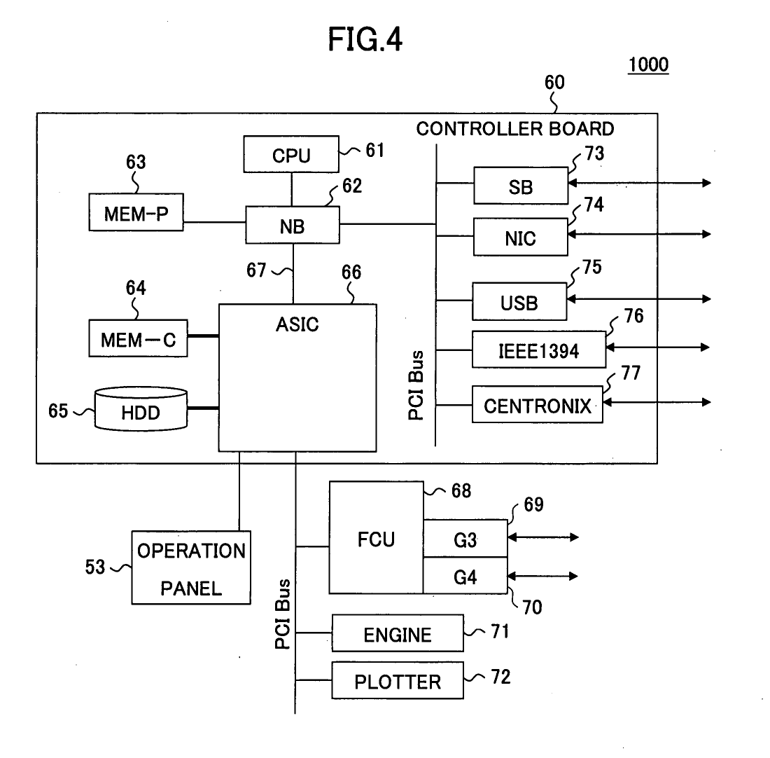

Next, a hardware configuration of the image processing apparatus 1000 according to an embodiment of the present invention is described with reference to FIG. 4.

The image processing apparatus 1000 includes, for example, a controller board 60, an operations panel 53, an FCU (Facsimile Control Unit) 68, an engine 71, and a plotter 72. Furthermore, the FCU 68 includes, for example, a unit 69 corresponding to the G3 standard and a unit 70 corresponding to the G4 standard.

The controller board 60 includes, for example, a CPU 61, an ASIC 66, a HDD 65, a local memory (MEM-C) 64, a system memory (MEM-P) 63, a north bridge (hereinafter referred to as “NB”) 62, a south bridge (hereinafter referred to as “SB”) 73, a NIC (Network Interface Card) 74, a USB device 75, a IEEE-1394 device 76, and a Centronix device 77.

The operations panel 53 is connected to the ASIC 66 of the controller board 60. Furthermore, the SB 73, the NIC 74, the USB device 75, the IEEE-1394 device 76, and the Centronix device 77 are connected to the NB 62 via a PCI bus.

Furthermore, the FCU 68, the engine 71, and the plotter 72 are connected to the ASIC 66 of the controller board 60 via a PCI bus.

It is to be noted that, in the controller board 60, the local memory 64 and the HDD 65, for example, are connected to the ASIC 66. Furthermore, the CPU 61 and the ASIC 66 are connected via a CPU chip set of the NB 62. Accordingly, connecting the CPU 61 and the ASIC 66 with the NB 62 accommodates a case where the interface of the CPU 61 is not disclosed.

It is to be noted that the ASIC 66 and the NB 62 are not connected by a PCI bus, but by an AGP (Accelerated Graphics Port) 67. Accordingly, loss of performance can be prevented by connecting the ASIC 66 and the NB 62 with the AGP 67 (instead of connecting the ASIC 66 and the NB 62 with a low speed PCI bus) for executing and/or controlling multiple processes.

The CPU 61 performs the overall control of the image processing apparatus 1000. The NB 62 is a bridge for connecting the CPU 61, the system memory 63, the SB 73, and the ASIC 66. The system memory 63 is a memory for storing the thumbnails (e.g. thumbnail images, replacement thumbnail images). The SB 73 is a bridge for connecting the NB 62 with another PCI bus and peripheral devices, for example. Furthermore, the local memory 64 is a memory for storing original image data (entire image data).

The ASIC 66 is an IC (Integrated Circuit) including an image processing hardware element which is to be used for image processing. The HDD 65 is a storage device for storing, for example, image data, text data, program data, font data, and form data. The operations panel 53 is a control part for receiving input from the user and for displaying information for the user. The thumbnails (including thumbnail images of an entire image and thumbnail images of a partial image) and replacement thumbnail images are displayed on the operations panel 53.

The original image storage portion 112 shown in FIG. 3 stores original image data in the HDD 65 or the local memory 64, for example. The attribute storage portion 113 stores attribute data corresponding to the original image data also in the HDD 65, the local memory 64 or an NV-RAM (Non-Volatile RAM, not shown), for example. The thumbnail image storage portion 115 and the replacement thumbnail storage portion 116 store thumbnail image data and replacement thumbnail image data in the system memory 63. The display portion 117 displays, for example, thumbnails (e.g. thumbnail images, replacement thumbnail images) in the operation panel 53.

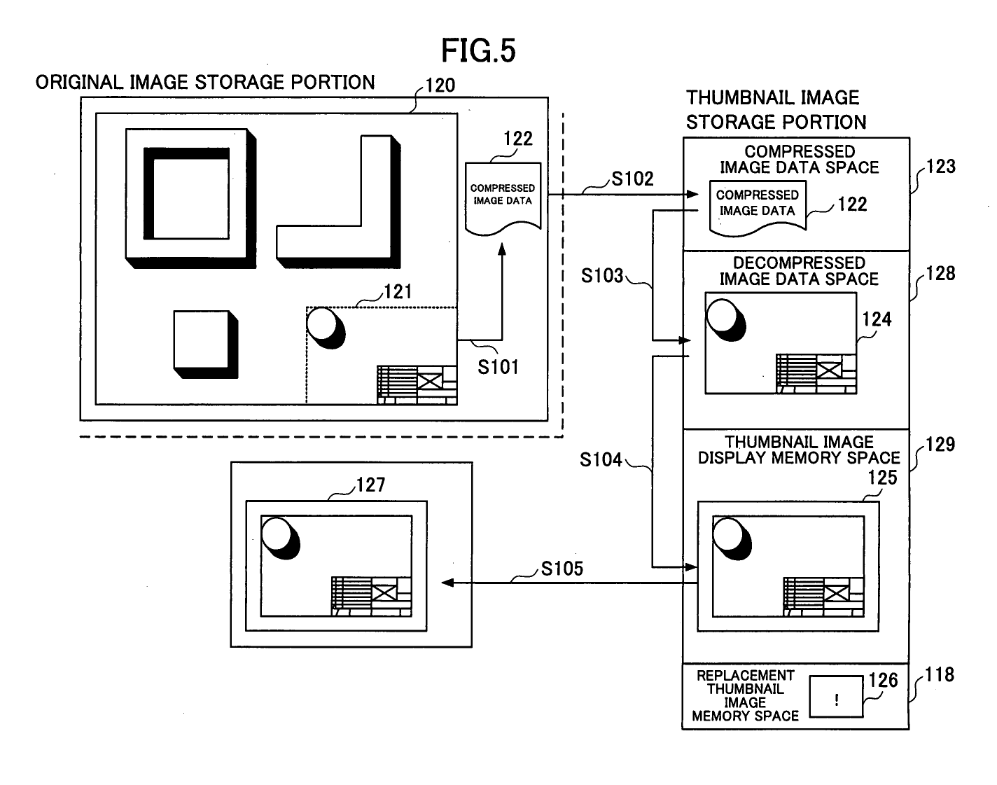

Next, the data used for displaying a thumbnail image based on an original image are described with reference to FIG. 5.

FIG. 5 shows an entire image (original image) 120, thumbnail images 124, 125, 127, a partial image 121, compressed image data 122, and a replacement thumbnail image 126. Furthermore, FIG. 5 shows a compressed image data space 123, a decompressed image data space 128, and a thumbnail image display memory space 129. These spaces are memory spaces managed by the thumbnail image storage portion 115.

The original image 120 corresponds to the original image data stored in the original image data storage portion 112. The original image may also be referred to as an entire image of the original image or simply referred to as an entire image. The partial image 121, in this example, is an image located at the lower right side of the original image 120. The partial image 121 is an image situated within the original image 120. The original image may be an element of the partial image.

The compressed image data 122 are compressed data of the image data corresponding to the partial image 121. The compressed image data 122 are decompressed and stored in the decompressed image data space 128. The image 124 is an image corresponding to the image data stored in the decompressed image data space 128. The image 125 is an image corresponding to the image data stored in the thumbnail image display memory space 129. The image 126 is a replacement thumbnail image corresponding to the replacement thumbnail image data stored in a replacement thumbnail image memory space 118. The image 127 is an image which is actually being displayed on the operations panel 53.

Next, the flow of the above-described data is described. In Step S101, the compressed image data 122 are generated by compressing the image data corresponding to the partial image 121. In Step S102, the compressed image data 122 are transferred to the compressed image data space 123. In Step S103, the compressed image data 122 are decompressed and are transferred to the decompressed image data space 128. In Step S104, the decompressed image data are transferred to the thumbnail display memory 129. In Step S105, a thumbnail image corresponding to the image data transferred to the thumbnail display memory 129 is displayed in the operations panel 53.

As described above, the transfer of image data is performed in Steps S102, S103, and S104. This transferring process consumes more resources as the image data size become larger. Therefore, in a case where the data size of the original image is large, the replacement thumbnail image is displayed, and the thumbnail of the large data size original image (i.e. original thumbnail image) is displayed when desired (requested) by the user. This allows resources to be used efficiently. Furthermore, the performance for displaying other images can be enhanced by not displaying images of large data size.

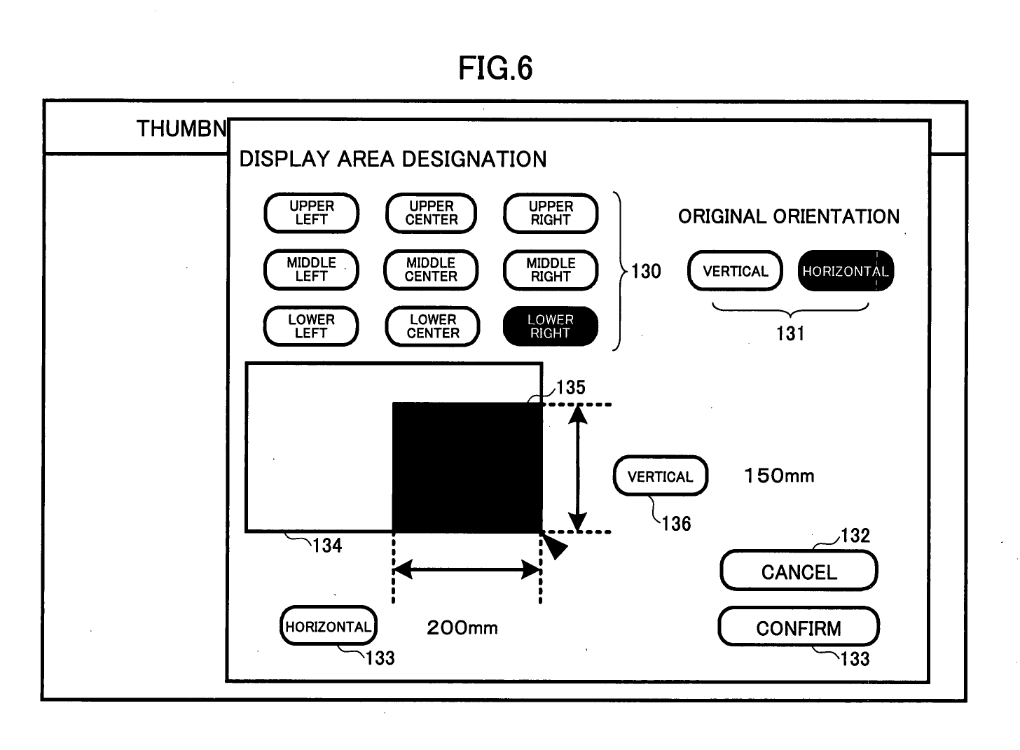

Next, a process of displaying a partial image as a thumbnail is described. FIG. 6 shows a screen displayed for the user in setting a partial image. More specifically, the screen shown in FIG. 6 is a screen for setting a display area. The screen in this example displays multiple starting point designation buttons 130, original (original copy) orientation buttons 131, a vertical button 136, a horizontal button 137, an entire image 134, a partial image 135, a cancel button 132, and a confirm button 133.

The starting point designation buttons 130 are for designating a starting point of the area (space) of a partial image. For example, when the user selects “lower right”, the area of the partial image 135 is set from the vertex at the lower right part of the entire image 134.

The original orientation buttons 131 are for setting the orientation (in this example, vertical direction, horizontal direction) of the original (original copy). For example, the entire image 134 is positioned vertically when the user selects “vertical”, and the entire image 134 is positioned horizontally when the user selects “horizontal”. The vertical button 136 is for inputting the distance from the designated starting point in the vertical direction. The horizontal button 137 is for inputting the distance from the designated starting point in the horizontal direction.

The cancel button 132 is for canceling the settings of the partial image 135. The confirm button 133 is for confirming the settings of the partial image 135.

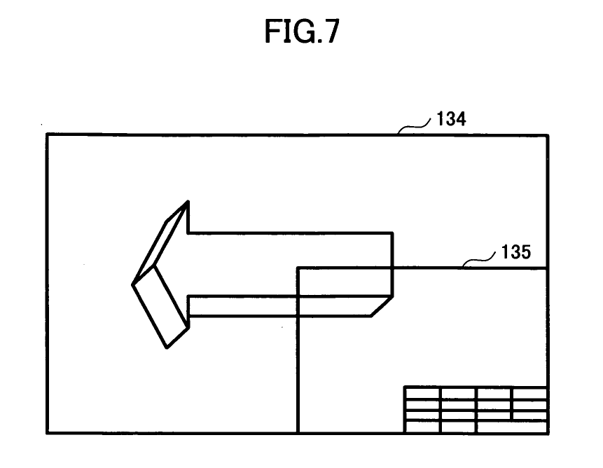

Next, the entire image 134 and the partial image 135 (in a case after the above-described setting of the partial image 135) are described with reference to FIG. 7. FIG. 7 shows the entire image 134 and the partial image 135 according to an embodiment of the present invention. As shown in FIG. 7, the partial image 135 is the rectangular-shaped area including the lower right vertex of the entire image 134. This area is displayed when displaying a thumbnail image of the partial image 135.

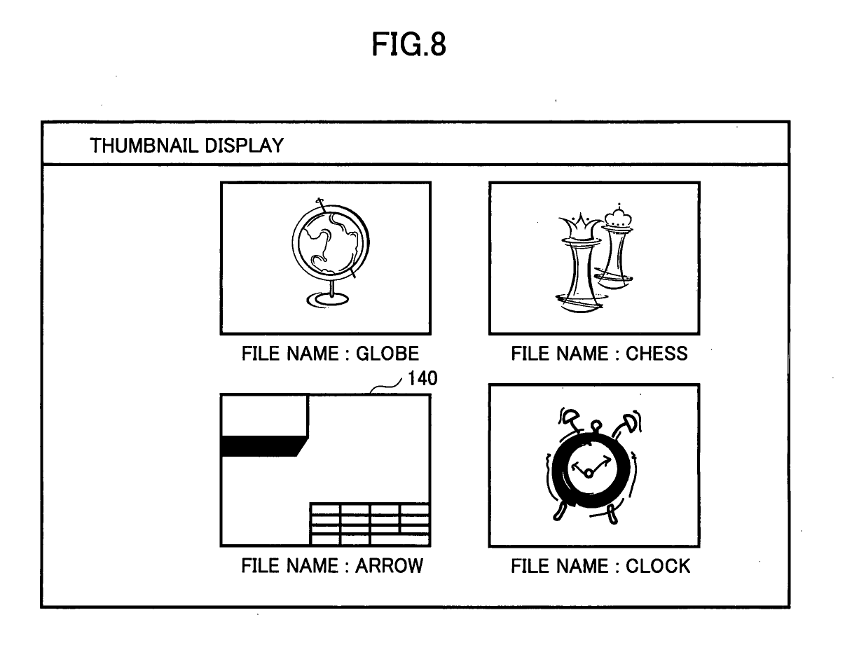

FIG. 8 shows a state where a thumbnail image of the partial image 135 is actually displayed according to an embodiment of the present invention. In FIG. 8, reference numeral 140 indicates the thumbnail image of the partial image 135 of FIG. 7.

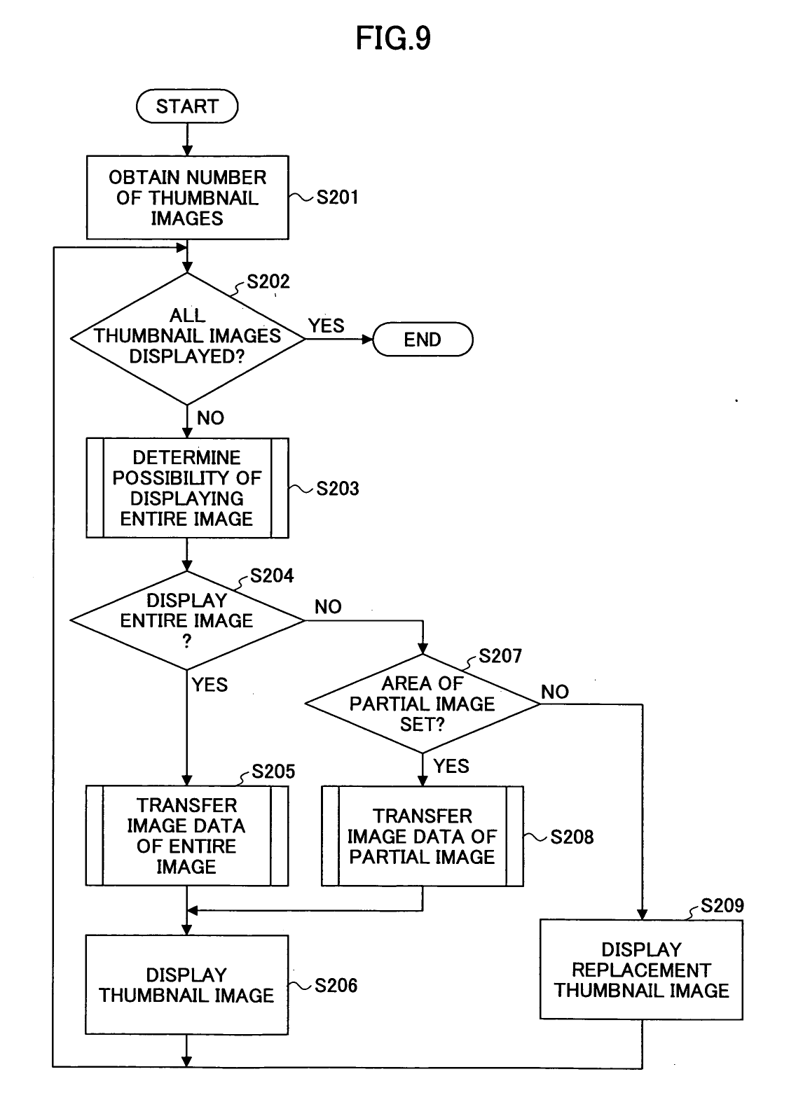

Next, a process for displaying a thumbnail image (thumbnail display process) is described with reference to FIG. 9. FIG. 9 is a flowchart showing a process for displaying a thumbnail image according to an embodiment of the present invention. In Step S201, the control portion 110 obtains the number of thumbnail images that are to be displayed. Next, in Step S202, the control portion 110 determines whether the display process of all of the thumbnail images is completed. In a case where the display process is completed, the thumbnail display process is finished.

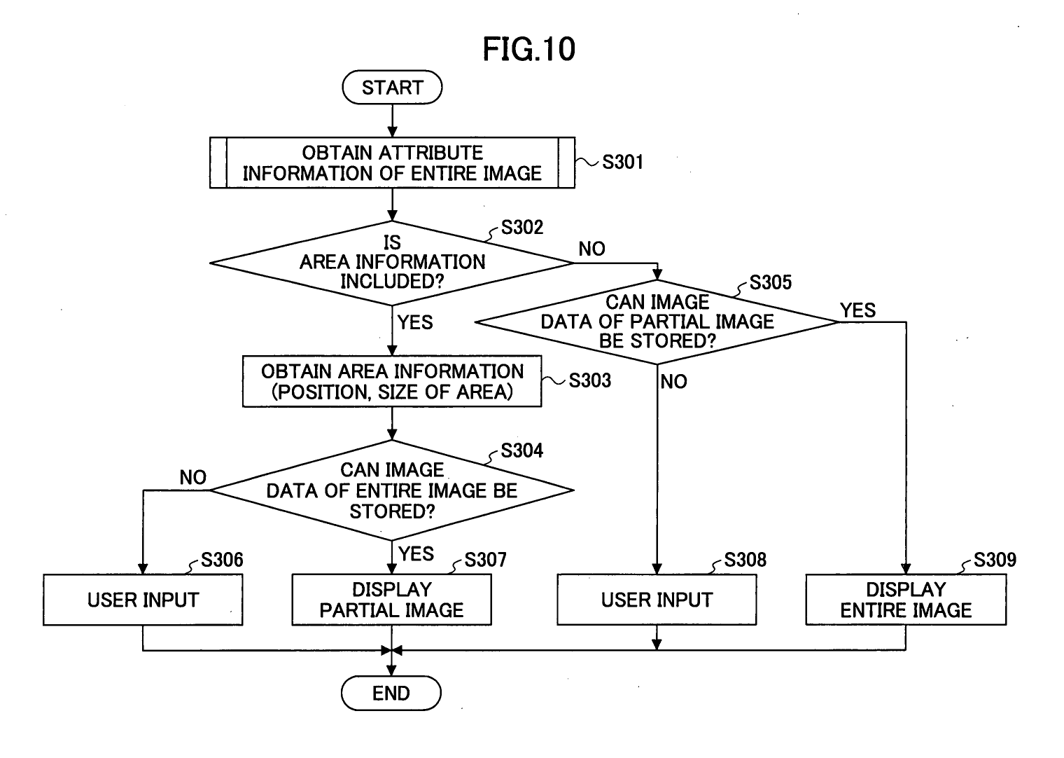

In a case where the display process is not completed, the thumbnail display process proceeds to Step S203. In Step S203, the control portion 110 determines whether it is possible to display a thumbnail of an entire image (this step is described in detail below with reference to the flowchart shown in FIG. 10).

Then, in Step S204, the control portion 110 determines whether to display a thumbnail of an entire image. In this step, the control portion 110 determines that a thumbnail of an entire image is to be displayed when the size of the area set by the user is greater than the entire image. In a case where the control portion 110 determines to display a thumbnail of the entire image (Yes in Step S204), the control portion 110 instructs the image process portion 111 to transfer image data (Step S205). In Step S206, a thumbnail image of the entire image is displayed by performing a display process. Then, the thumbnail display process returns to Step S202.

Meanwhile, in a case where the control portion 110 determines not to display a thumbnail of an entire image in Step S204, the control portion 110 determines whether an area of a partial image of the entire image is set (Step S207). In a case where the area of the partial image is set (Yes in Step S207), the control portion 110 instructs the image process part 111 to transfer the image data of the partial image corresponding to the set area. Then, in Step S206, a thumbnail of the partial image is displayed.

Meanwhile, in a case where the control portion 110 determines that the area of the partial image is not set (No in Step S207), the control portion 110 instructs the display management portion 114 to display a replacement thumbnail image (Step S209). In this case, the file name of the original image (entire image) that was initially supposed to be displayed is indicated with the replacement thumbnail image.

The Steps S204 and S207 correspond to a determining step according to an embodiment of the present invention. The Step S209 corresponds to a replacement thumbnail image display step according to an embodiment of the present invention.

Next, the above-described Step S203 is described in further detail with reference to the flowchart shown in FIG. 10. In Step S301, the control portion 110 obtains attribute information of the image data of the entire image (original image). In Step S302, the control portion 110 determines whether the attribute information of the original image data includes area information for a partial image (e.g. position, size of area) of the entire image (original image). The attribute information may include, for example, the type of image data (e.g. image data for drawings, planning documents (blueprints), etc.). The attribute information may be, for example, set in correspondence with the image data, or set in correspondence with a predetermined area of a partial image. Accordingly, in a case where the attribute information of the image data includes area information for a partial image (e.g. position, size of area) of the entire image (original image), a thumbnail image is displayed in accordance with the area information.

In a case where area information for the partial image is included in the attribute information (Yes in Step S302), the control portion 110 obtains the area information for the partial image from the attribute information (Step S303). Next, the control portion 110 determines whether the image data corresponding to the area information of the partial image has a size that can be stored in the thumbnail image display memory space 129 (Step S304). In a case where the control portion 110 determines that the image data corresponding to the area information of the partial image has a size that can be stored in the thumbnail image display memory space 129 (Yes in Step S304), the control portion 110 determines that the partial image is to be displayed. In a case where the control portion 110 determines that the image data has a size that cannot be stored in the thumbnail image display memory space 129 (No in Step S304), the control portion 110 prompts (requests) the user to set the area of the partial image (Step S306).

Meanwhile, in a case where the control portion 110 determines that the area information is not included in the attribute information (No in Step S302), the control portion 110 determines whether the image data of the original image has a size that can be stored in the thumbnail image display memory space 129 (Step S305). In a case where the control portion 110 determines that the image data of the original image has a size that can be stored in the thumbnail image display memory space 129, the control portion 110 determines that the original image be entirely displayed (display the entire image) (Step S309). In a case where the control portion 110 determines that the image data of the original image has a size that cannot be stored in the thumbnail image display memory space 129, the control portion 110 prompts (requests) the user to set the area of the original image (Step S308).

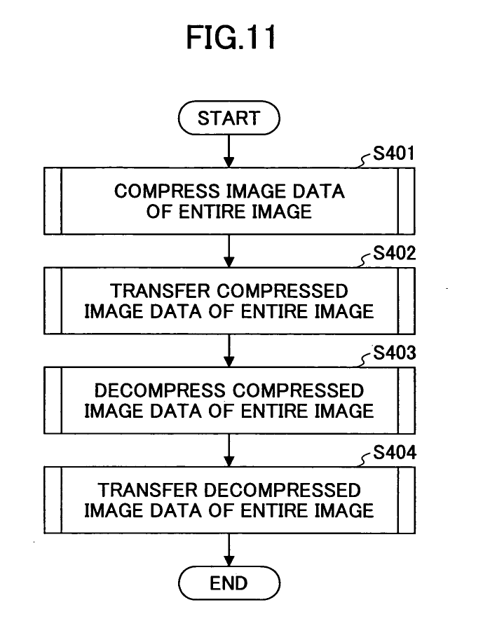

Next, Step S205 of FIG. 9 is described with reference to the flowchart shown in FIG. 11. In Step S401, the image process portion 111 compresses the data of the original image (entire image). In Step S402, the image process portion 111 transfers the compressed image data of the original image (entire image) to the thumbnail image storage portion 115.

Next, the display management portion 114 decompresses the compressed image data of the original image (entire image) (Step S403). Then, the display management portion 114 transfers the decompressed image data of the original image (entire image) to the thumbnail image display memory space 129 by using, for example, DMA transfer (Step S404).

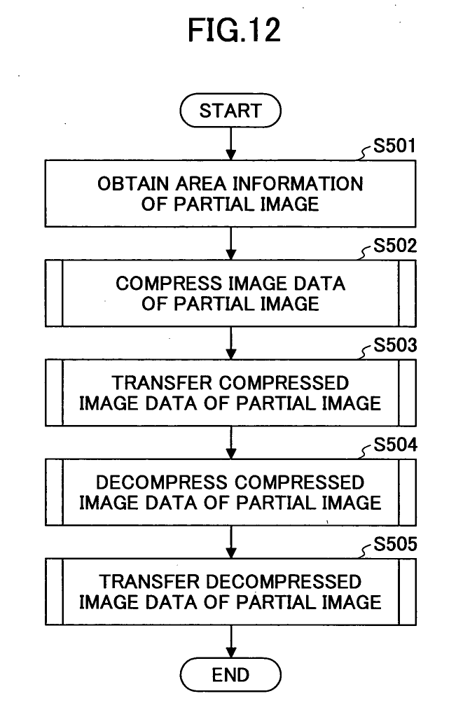

Next, Step S208 of FIG. 9 is described with reference to the flowchart shown in FIG. 12. In Step S501, the control portion 110 obtains area information of the partial image of the original image. In Step S502, the image process part 110 compresses the image data of the partial image. In Step S503, the image process portion 111 transfers the compressed image data of the partial image to the thumbnail image storage portion 115.

Next, the display management portion 114 decompresses the compressed image data of the partial image (Step S504). Then, the display management portion 114 transfers the decompressed image data of the partial image to the thumbnail image display memory space 129 by using, for example, DMA transfer (Step S505).

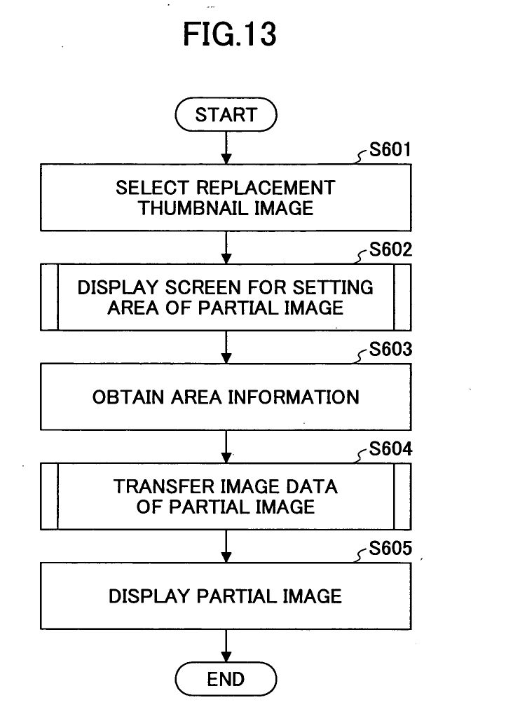

Next, a process of selecting a replacement thumbnail image (for canceling the withholding of displaying an original thumbnail image (partial image) and displaying the original thumbnail image (partial image) is described with reference to the flowchart shown in FIG. 13. First, the control portion 110 recognizes the selection of the replacement thumbnail image by the user and determines that withholding the displaying of the original thumbnail image has been canceled (Step S601). The control portion 110 displays a screen for allowing the user to set the area of the partial image of the entire image (original image). In Step S603, the control portion 110 obtains information (data) for setting the area of the partial image (i.e. partial image data), for example, in accordance with the area set by the user. In Step S604, the image process portion 111 transfers the partial image data to the display management portion 114. Then, in Step S605, the display management portion 114 displays the thumbnail image of the partial image.

### Second Embodiment

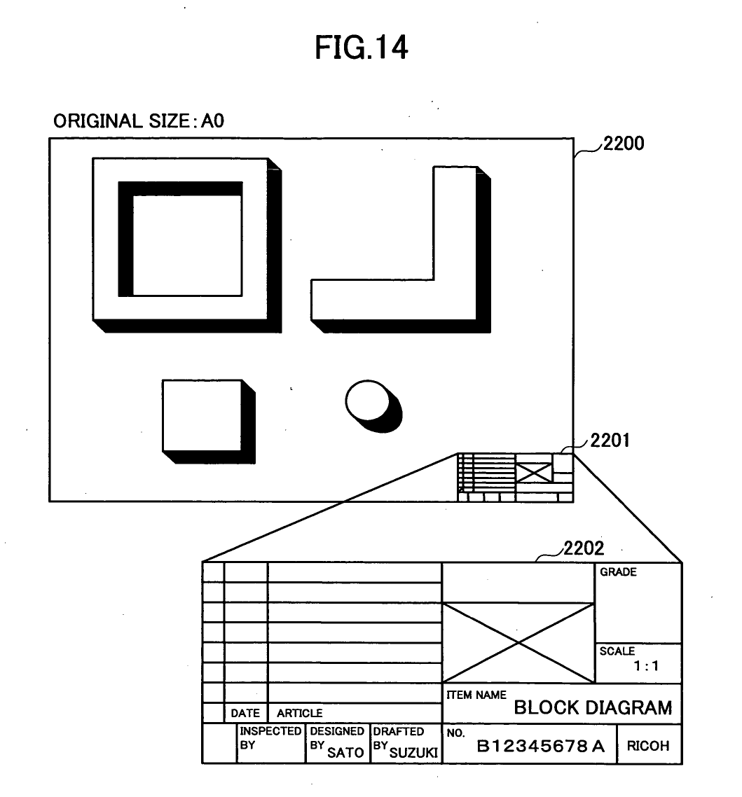

First, a large image having a large size is described with reference to FIG. 14. FIG. 14 shows an image 2200 of A0 size. In FIG. 14, reference numeral 2201 indicates an image which is a portion of the image 2200. Reference numeral 2202 indicates an enlarged image 2202 of the image 2201. An image which is displayed in the entire area (in this example, image 2200) is hereinafter referred to as “entire image”. Furthermore, an image which is displayed in a part of the area (in this example, image 2201) is hereinafter referred to as “partial image”. It is to be noted that the entire image may be included in a partial image.

In this example, the information displayed in the image 2202 is enough information for a drawing. Therefore, in a case of a displaying a preview image of a drawing, the image 2202 is an appropriate preview image.

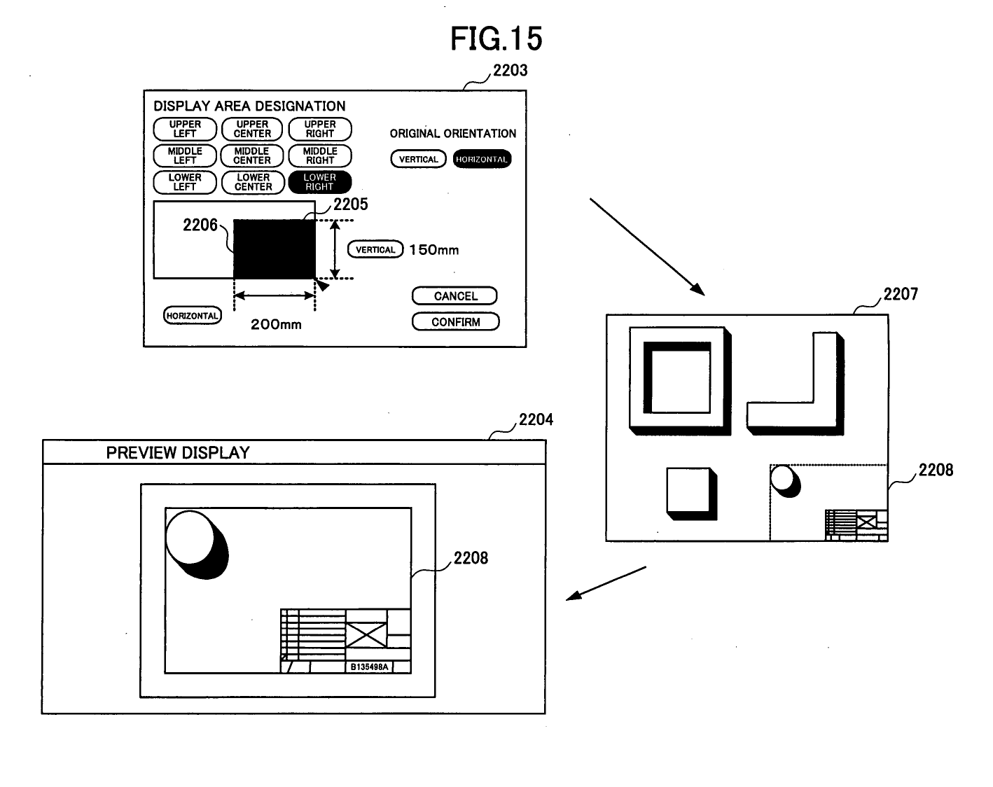

FIG. 15 shows a partial image area setting screen 2203 (i.e. a screen used in setting a display area of a partial image) and a preview display screen 2204 (i.e. a screen displaying a preview image) according to an embodiment of the present invention. By using the partial image area setting screen 2203, an area 2206 of a partial image 2208 (partial image area) in an area 2205 of an entire image 2207 (entire image area) can be set. By setting the partial image area 2206, the partial image 2208 of the entire image 2207 is displayed as a preview image in the preview display screen 2204.

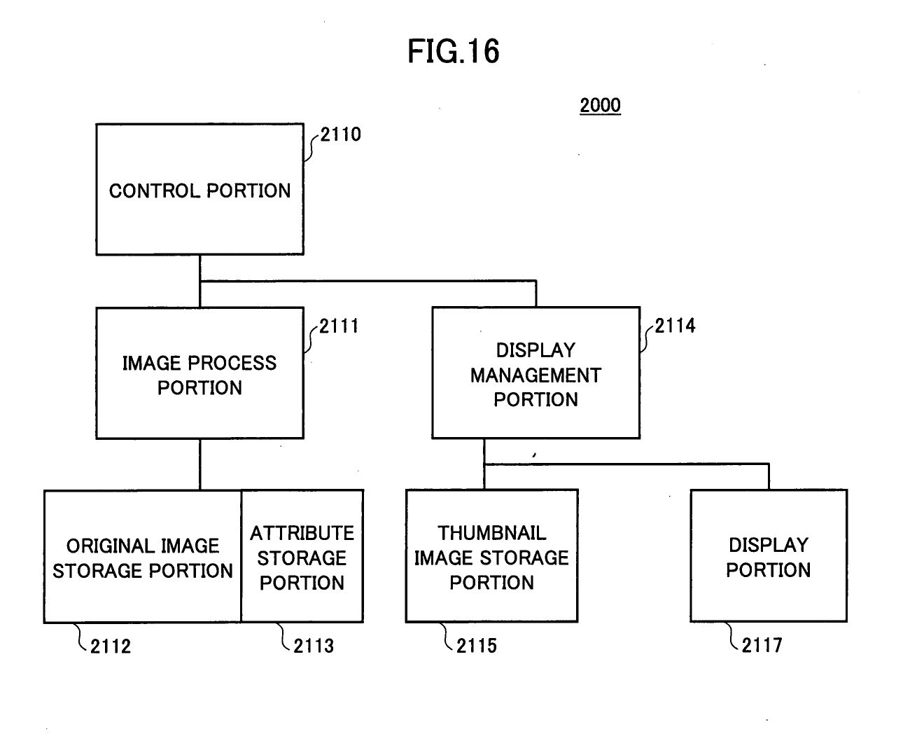

FIG. 16 is a block diagram showing a software configuration of an image processing apparatus 2000 according to the second embodiment of the present invention. FIG. 16 shows a control portion 2110, an image process portion 2111, an original image storage portion 2112, an attribute storage portion 2113, a display management portion 2114, a preview image storage portion 2115, and a display portion 2117.

The control portion 2110 performs the overall control of the image processing apparatus 2000. The image process portion 2111 performs various processes on image data (e.g. compression of image data of various images, generation of preview image data of various images). The image process portion 2111, for example, generates preview image data in correspondence with original image data. The original image storage portion 2112 stores original image data. The attribute storage portion 2113 stores attribute data corresponding to the original image data. The display management portion 2114 manages the displaying of the preview images. The preview image storage portion 2115 stores preview image data. The display portion 2117 displays images including, for example, original images (entire images) and preview images (partial images).

It is to be noted that the control portion 2110 corresponds to an area setting part. The image process portion 2111 corresponds to an attribute setting part. The original image storage portion 2112 corresponds to an original image storage part. The display management portion 2114 and the display portion 2117 correspond to a displaying part. The preview image storage portion 2115 corresponds to a preview image storage part. The display management portion 2114 also corresponds to an attribute registering part.

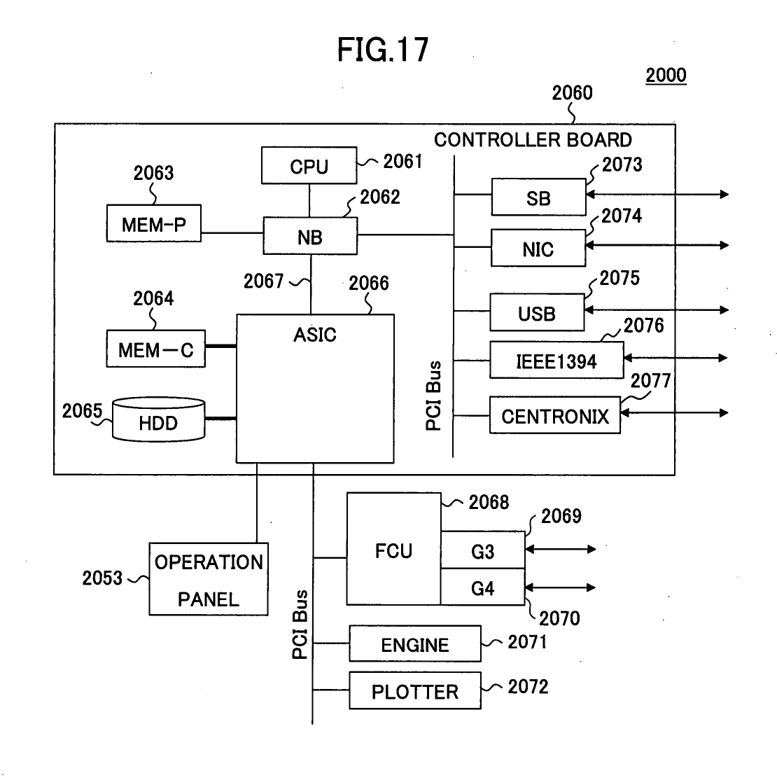

Next, a hardware configuration of the image processing apparatus 2000 according to the second embodiment of the present invention is described with reference to FIG. 17.

The image processing apparatus 2000 includes, for example, a controller board 2060, an operations panel 2053, an FCU (Facsimile Control Unit) 2068, an engine 2071, and a plotter 2072. Furthermore, the FCU 2068 includes, for example, a unit 2069 corresponding to the G3 standard and a unit 2070 corresponding to the G4 standard.

The controller board 2060 includes, for example, a CPU 2061, an ASIC 2066, a HDD 2065, a local memory (MEM-C) 2064, a system memory (MEM-P) 2063, a north bridge (hereinafter referred to as “NB”) 2062, a south bridge (hereinafter referred to as “SB”) 2073, a NIC (Network Interface Card) 2074, a USB device 2075, a IEEE-1394 device 2076, and a Centronix device 2077.

The operations panel 2053 is connected to the ASIC 2066 of the controller board 2060. Furthermore, the SB 2073, the NIC 2074, the USB device 2075, the IEEE-1394 device 2076, and the Centronix device 2077 are connected to the NB 2062 via a PCI bus.

Furthermore, the FCU 2068, the engine 2071, and the plotter 2072 are connected to the ASIC 2066 of the controller board 2060 via a PCI bus.

It is to be noted that, in the controller board 2060, the local memory 2064 and the HDD 2065, for example, are connected to the ASIC 2066. Furthermore, the CPU 2061 and the ASIC 2066 are connected via a CPU chip set of the NB 2062. Accordingly, connecting the CPU 2061 and the ASIC 2066 with the NB 2062 accommodates a case where the interface of the CPU 2061 is not disclosed.

It is to be noted that the ASIC 2066 and the NB 2062 are not connected by a PCI bus, but by an AGP (Accelerated Graphics Port). Accordingly, loss of performance can be prevented by connecting the ASIC 2066 and the NB 2062 with the AGP 2035 (instead of connecting the ASIC 2066 and the NB 2062 with a low speed PCI bus) for executing and/or controlling multiple processes.

The CPU 2061 performs the overall control of the image processing apparatus 2000. The NB 2062 is a bridge for connecting the CPU 2061, the system memory 2063, the SB 2073, and the ASIC 2066. The system memory 2063 is a memory for temporarily storing, for example, preview images. The SB 2073 is a bridge for connecting the NB 2062 with another PCI bus and peripheral devices, for example. Furthermore, the local memory 2064 is a memory for storing original image data (entire image data).

The ASIC 2066 is an IC (Integrated Circuit) including an image processing hardware element which is to be used for image processing. The HDD 2065 is a storage device for storing, for example, image data, text data, program data, font data, and form data. The operations panel 2053 is a control part for receiving input from the user and for displaying information for the user. The preview images are displayed on the operations panel 2053.

The original image storage portion 2112 shown in FIG. 16 stores original image data in the HDD 2065 or the local memory 2064, for example. The attribute storage portion 2113 stores attribute data corresponding to the original image data also in the HDD 2065, the local memory 2064 or an NV-RAM (Non-Volatile RAM, not shown), for example. The preview image storage portion 2115 stores preview image data in the system memory 2063. The display portion 2117 displays, for example, preview images in the operations panel 2053.

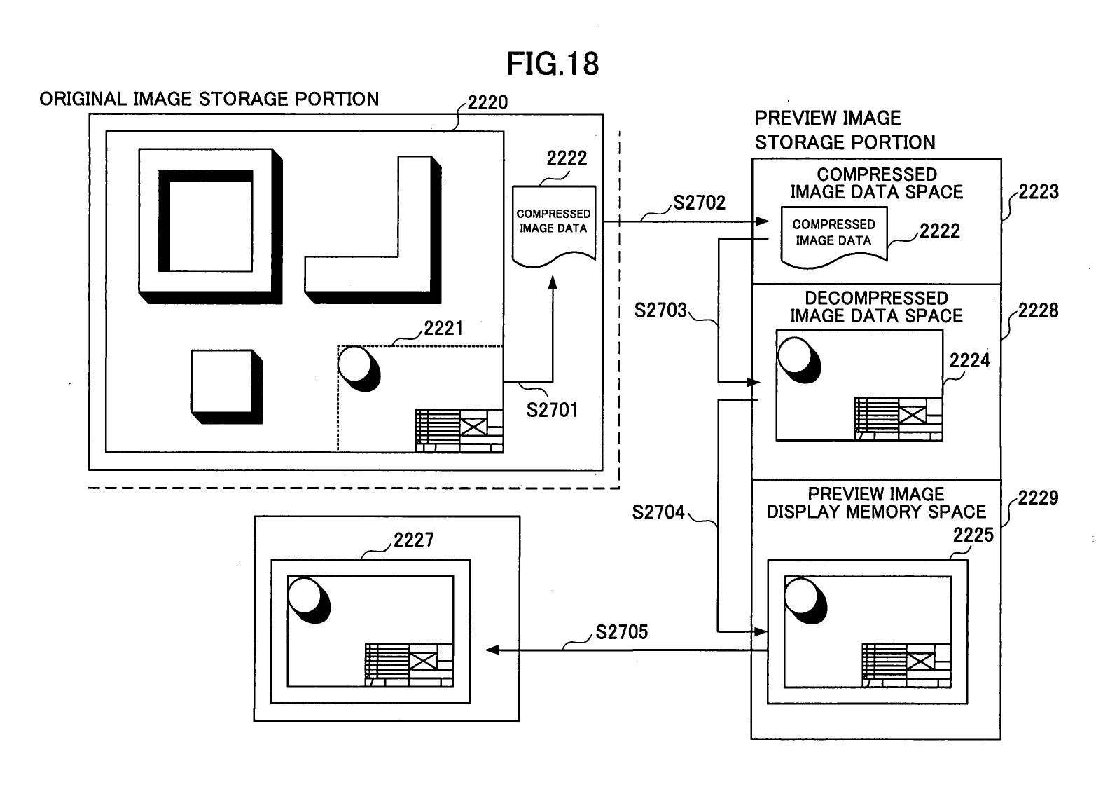

Next, the data used for displaying a preview image based on an original image (entire image) are described with reference to FIG. 18.

FIG. 18 shows an entire image (original image) 2220, a partial image 2221, preview images 2224, 2225, 2227, and compressed image data 2222. Furthermore, FIG. 18 shows a compressed image data space 2223, a decompressed image data space 2228, and a preview image display memory space 2229. These spaces are memory spaces managed by the preview image storage portion 2115.

The original image 2220 corresponds to the original image data stored in the original image data storage portion 2112. The partial image 2221, in this example, is an image located at the lower right side of the original image (entire image) 2220.

The compressed image data 2222 are compressed data of the image data corresponding to the partial image 2221. The compressed image data 2222 are decompressed and stored in the decompressed image data space 2228. The image 2224 is an image corresponding to the image data stored in the decompressed image data space 2228. The image 2225 is an image corresponding to the image data stored in the preview image display memory space 2229. The image 2227 is an image which is actually to be displayed on the operations panel 2053.

Next, the flow of the above-described data is described. In Step S2701, the compressed image data 2222 are generated by compressing the image data corresponding to the partial image 2221. In Step S2702, the compressed image data 2222 are transferred to the compressed image data space 2223. In Step S2703, the compressed image data 2222 are decompressed and are transferred to the decompressed image data space 2228. In Step S2704, the decompressed image data are transferred to the preview display memory 2229. In Step S2705, a preview image corresponding to the image data transferred to the preview display memory 2229 is displayed in the operations panel 2053.

Next, a screen used for setting the display of a preview image is described.

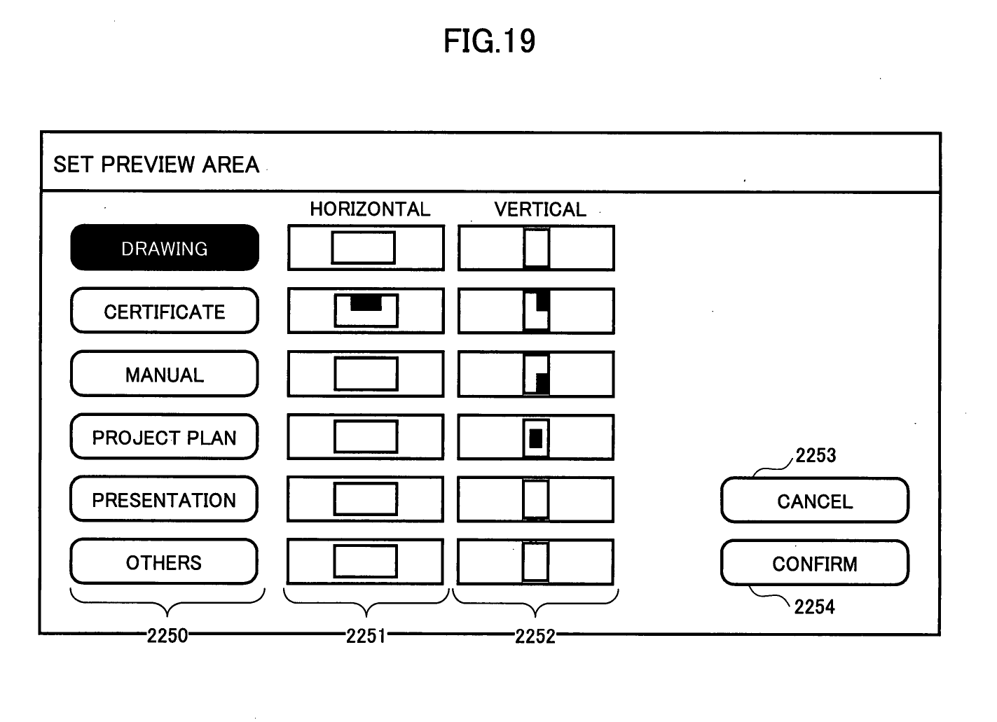

FIG. 19 is a schematic diagram showing a screen used for setting an area for a preview image (preview display area setting screen) according to an embodiment of the present invention. FIG. 19 shows multiple attribute buttons 2250, a horizontal image display column 2251, a vertical image display column 2252, a cancel button 2253, and a confirm button 2254.

First, the attribute buttons 2250 are described below. The “attributes” of the attribute buttons 2250, in this example, indicate the group to which image data belong. Based on the type of image data, image data are categorized into multiple groups. In the example shown in FIG. 19, the groups include “drawings”, “certificates”, “manuals”, “project plans”, “presentations”, and “others”. The groups can be set by the user, for example. The attribute buttons 2250 are for setting the area of the partial image in correspondence with the groups.

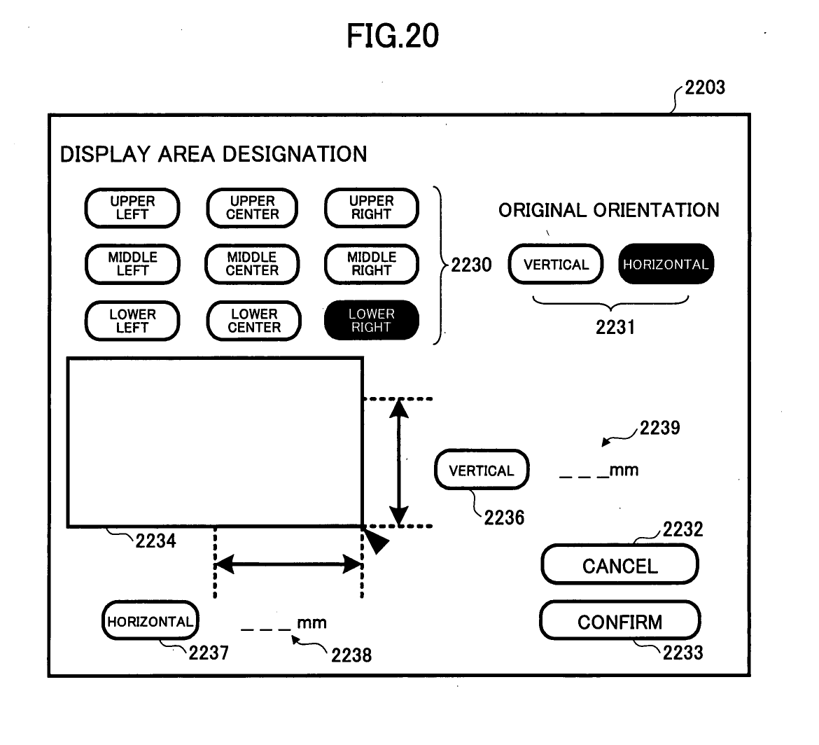

Next, a screen for setting the area of the partial image (partial image area setting screen) 2203 is described. FIG. 20 is a schematic diagram showing the partial image area setting screen 2203 that is displayed when one of the attribute buttons 2250 is selected. The partial image area setting screen 2203, in this example, displays multiple starting point designation buttons 2230, original (original copy) orientation buttons 2231, a vertical button 2236, a horizontal button 2237, an entire image 2234, a cancel button 2232, a confirm button 2233, a horizontal value input space 2238, and a vertical value input space 2239.

The starting point designation button 2230 is for designating a starting point of the area (space) of the partial image. For example, when the user selects “lower right”, the area of the partial image 2235 is set from the vertex at the lower right part of the entire image 2234.

The original orientation buttons 2231 are for setting the orientation (in this example, vertical direction, horizontal direction) of the original (original copy). For example, the entire image 2234 is positioned vertically when the user selects “vertical”, and the entire image 2234 is positioned horizontally when the user selects “horizontal”. The vertical button 2236 is for inputting the distance from the designated starting point with respect to the vertical direction in the vertical value input space 2239. The horizontal button 2237 is for inputting the distance from the designated starting point with respect to the horizontal direction in the horizontal value input space 2238. The values may be input with, for example, a numeric pad of an input apparatus (not shown) or a user interface provided on the screen. Among the starting point designation buttons 2230, the distance from a designated starting point may, for example, become twice the distance with respect to buttons indicated as “middle” or “center”.

The cancel button 2232 is for canceling the settings of the partial image 2235. The confirm button 2233 is for confirming the settings of the partial image 2235.

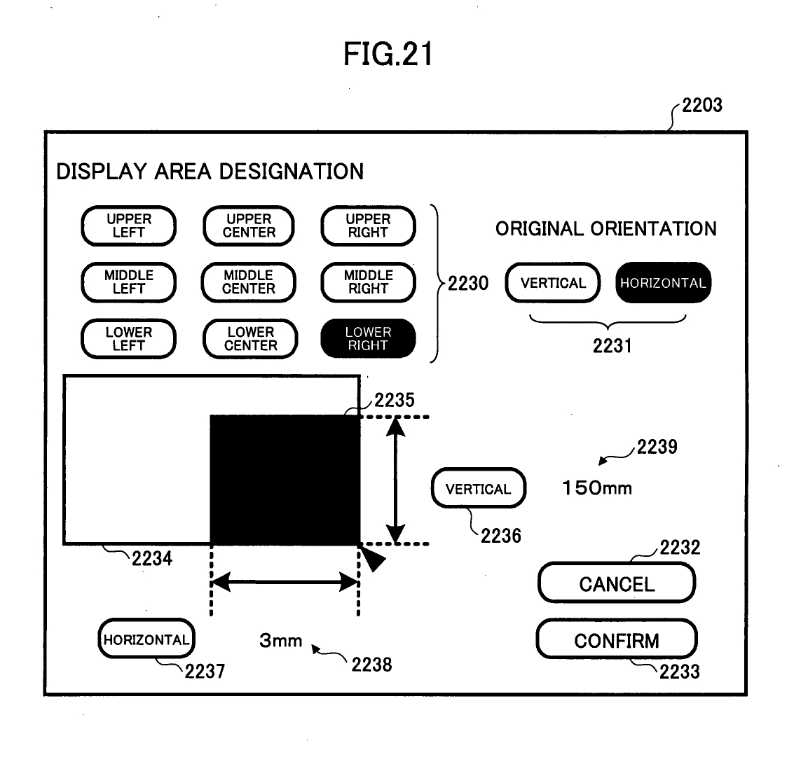

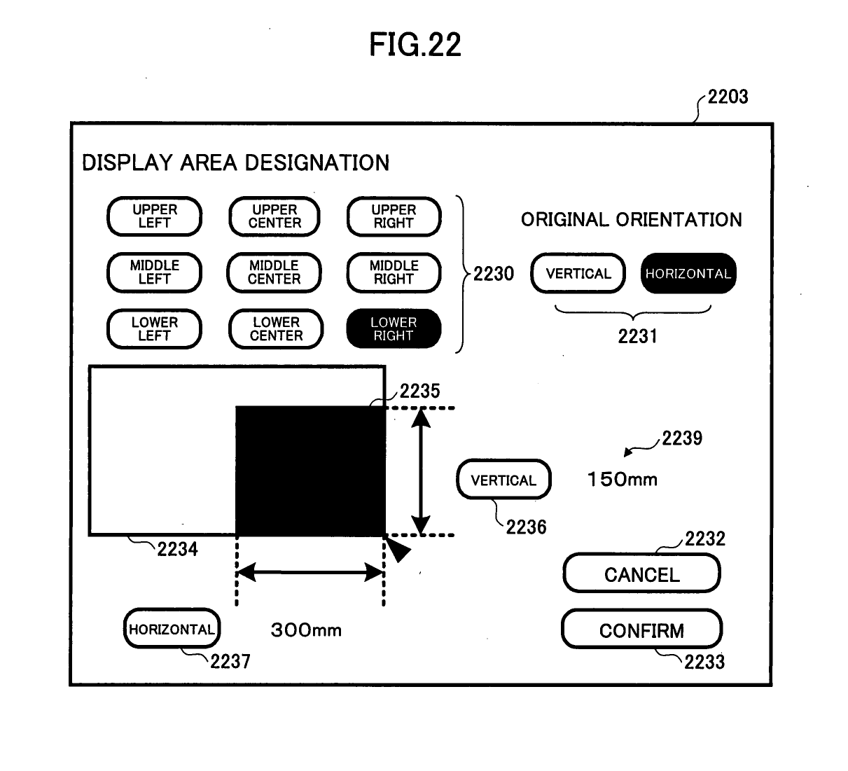

FIG. 21 shows the partial image area setting screen 2203 in the midst of having horizontal and vertical values input thereto. In FIG. 21, a value of “150” is input in the vertical value input space 2239 and a value of “3” is input in the horizontal value input space 2238. FIG. 22 shows the partial image area setting screen 2203 subsequent to having horizontal and vertical values input thereto. In FIG. 22, a value of “300” is input in the horizontal value input space, thereby completing the input of horizontal and vertical values.

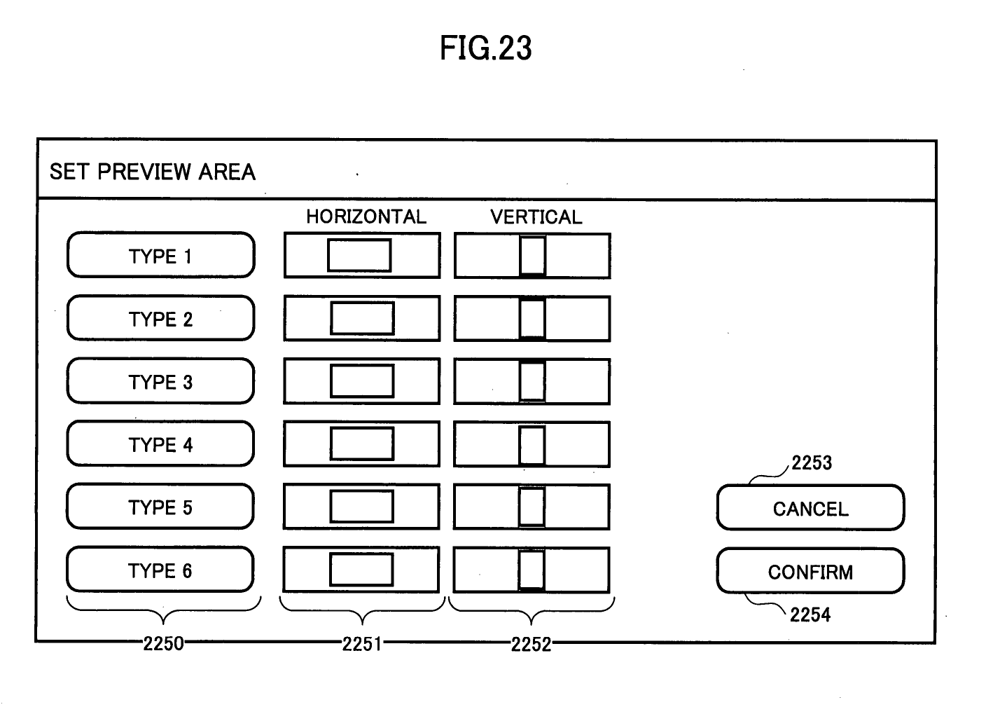

Next, a process where the user inputs the kinds of the attributes is described. FIG. 23 shows the preview display area setting screen in a state before the various attributes are input. The attribute buttons 2250 exemplarily shown in FIG. 23 are divided into six types (Type 1 through Type 6).

An example, in which an attribute “drawing” is set (input) as the attribute button for “Type 1”, is described.

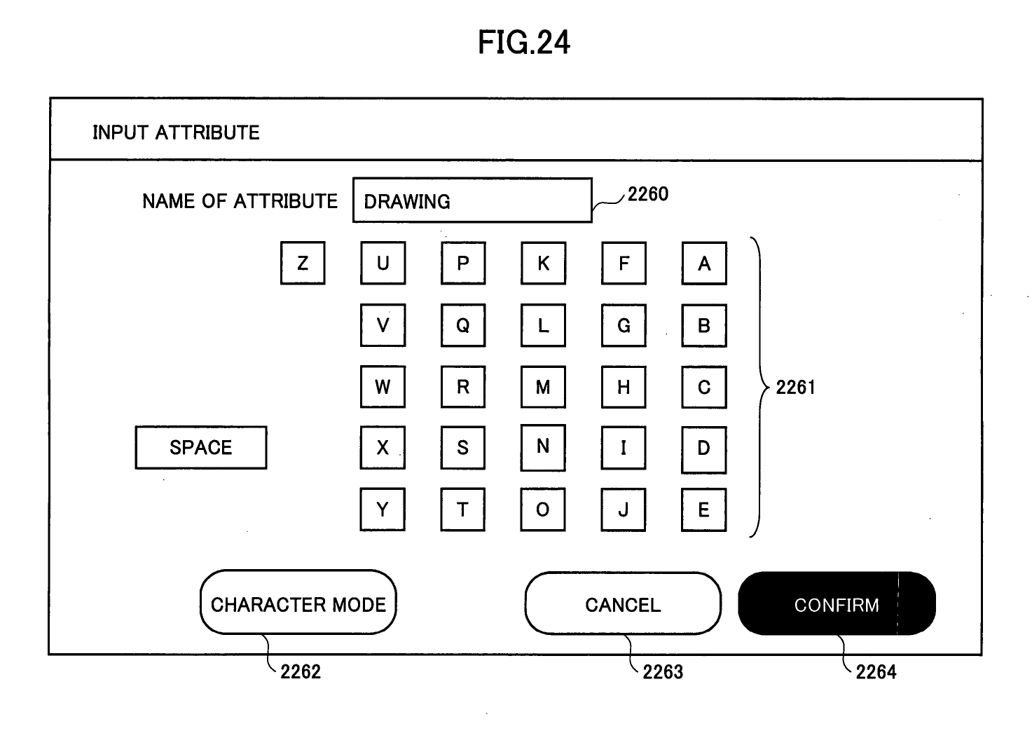

An attribute input screen shown in FIG. 24 is used for inputting the attributes. The attribute input screen displays, for example, an attribute input space 2260, multiple character buttons 2261, an input mode button 2262, a cancel button 2263, and a confirmation button 2264.

The attribute input space 2260 displays the attribute which is input by the user. The character buttons 2261 are for inputting characters (e.g. letters, symbols). The input mode button 2262 is for altering the type of character used for input (e.g. alphabet letters, numerals, symbols, etc.). The cancel button 2263 is for canceling the inputting of the attribute.

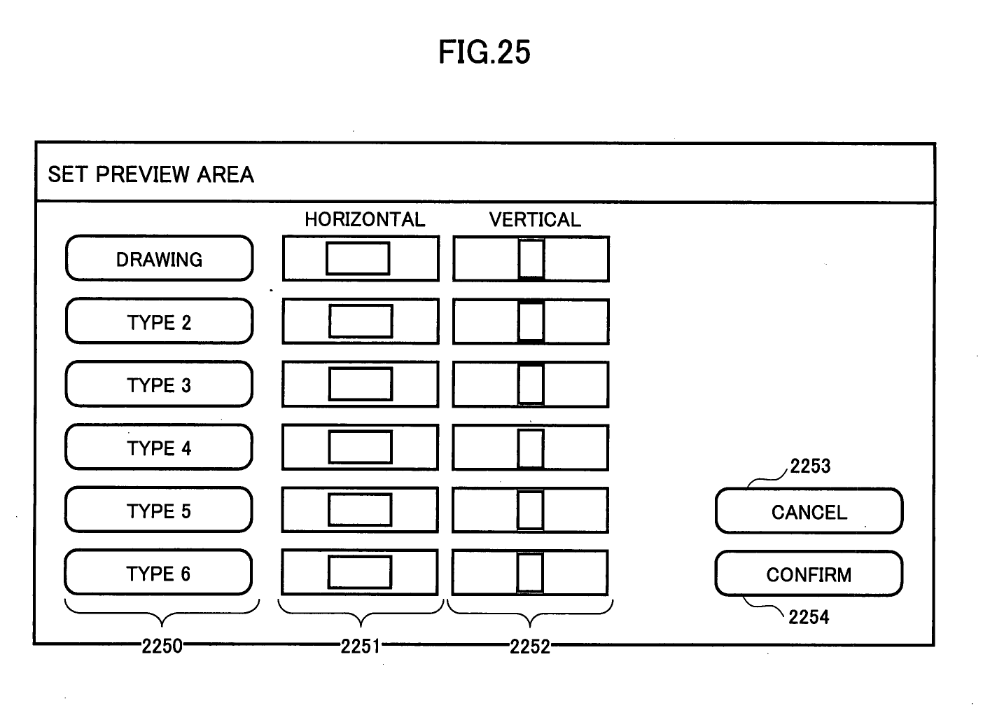

By inputting “drawing” with the character buttons 2261 and selecting the confirm button 2264, an attribute “drawing” is set as the attribute corresponding to “Type 1”, and is displayed as “drawing” in the attribute button 2250 as shown in FIG. 25.

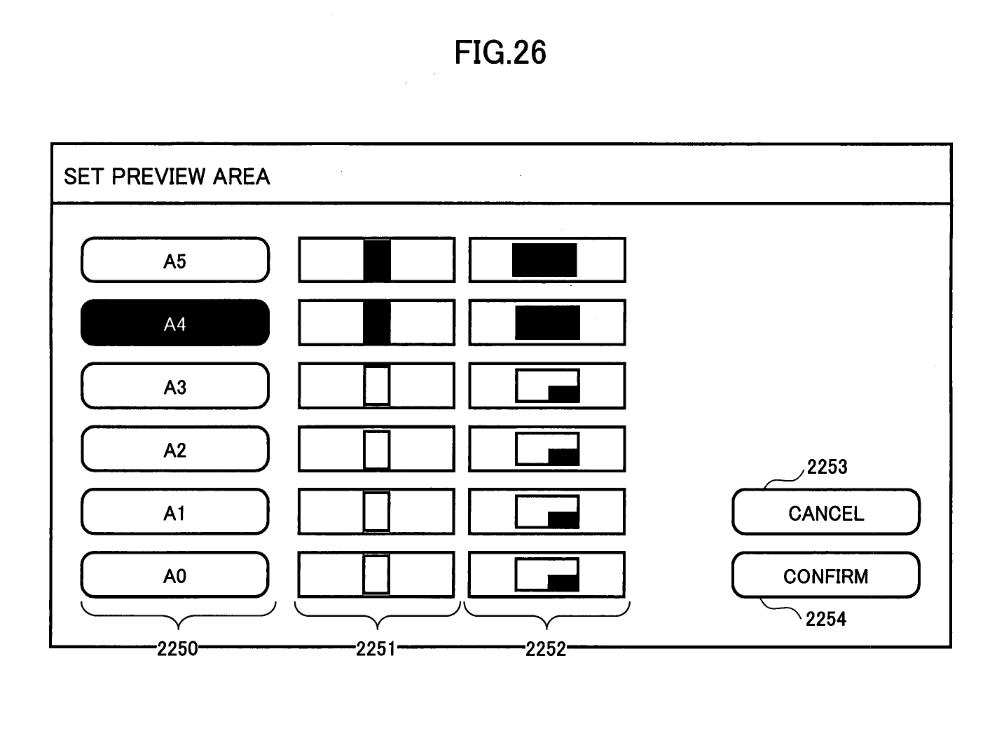

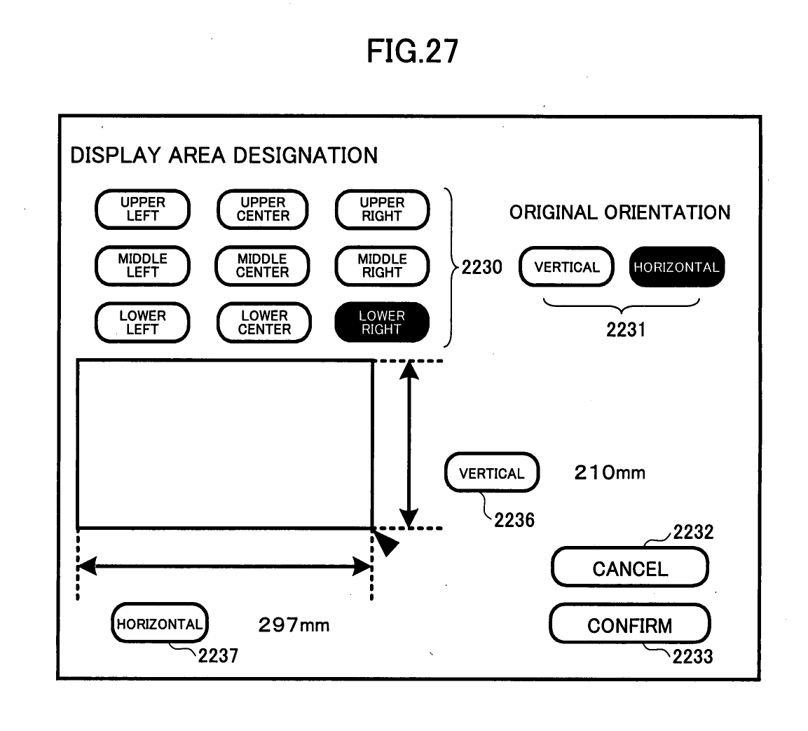

Another example, in which other kinds of attributes are displayed in the attribute buttons 2250, is described with reference to FIG. 26. The attribute buttons 2250 in this example display various A series paper standards (A0 to A5). In this example, since size A5 and size A4 are relatively small paper sizes, the preview image corresponding to A4 or A5 may be displayed in the form of an entire image rather than a partial image. For example, in a case where the attribute button 2250 corresponding to A4 is selected, a partial image area setting screen as shown in FIG. 27 is displayed. In the partial image area setting screen of FIG. 27, the preview image is a preview image showing the entire image. Accordingly, the attribute of the image may alternatively be the size of the image (size of the original). Furthermore, as in the example of selecting the attribute button 2250 corresponding to size A4, the area of the preview image (partial image) may set to display the entire image.

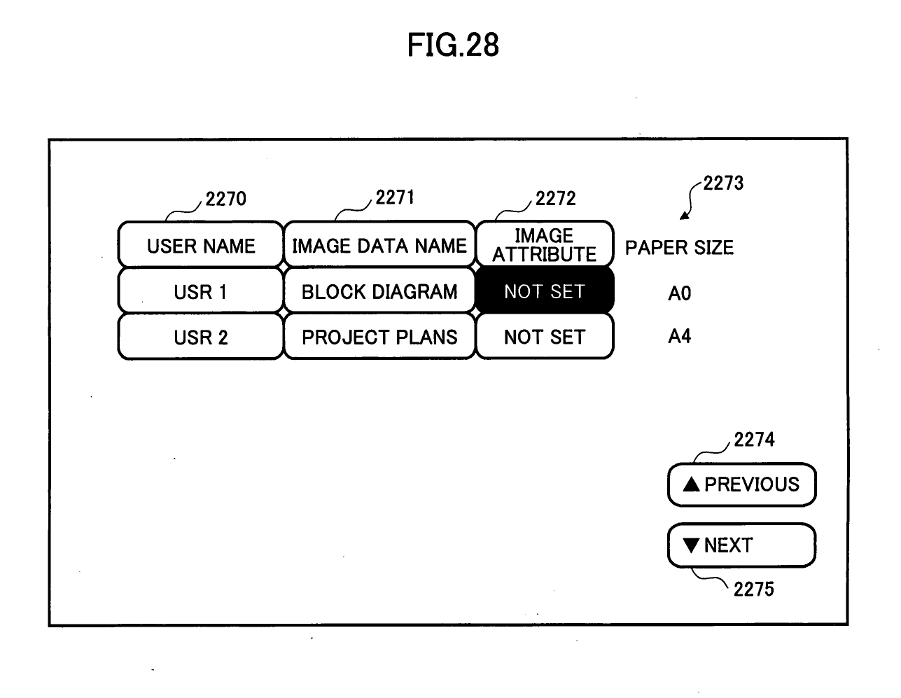

Next, an example of setting an attribute(s) in correspondence with image data is described with reference to FIG. 28. By setting the attribute(s) in correspondence with image data, a preview image(s) corresponding to the image data can be automatically displayed.

FIG. 28 shows a screen of an image table (image table screen) according to an embodiment of the present invention. The screen shown in FIG. 28 displays an image table including a user name column 2270, an image name column 2271, an image attribute column 2272, an original size column 2273, a previous button 2274, and a next button 2275. The user name column 2270 is for displaying the name of the user owning the image data. The image name column 2271 is for displaying the name (title) of the image data. The image attribute column 2272 is for displaying the attribute of the image data. In FIG. 28, since the attributes are not yet set in this example, the image attribute column 2272 is displayed as “not set”. The original size column 2273 is for displaying the size of the paper when the image is printed. The previous button 2274 is for displaying a screen displayed previous to this image table screen. The next button 2275 is for displaying a screen displayed after this image table screen.

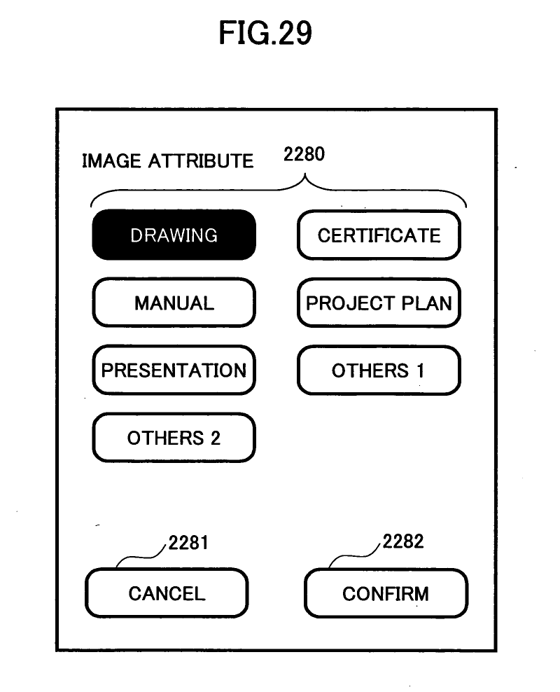

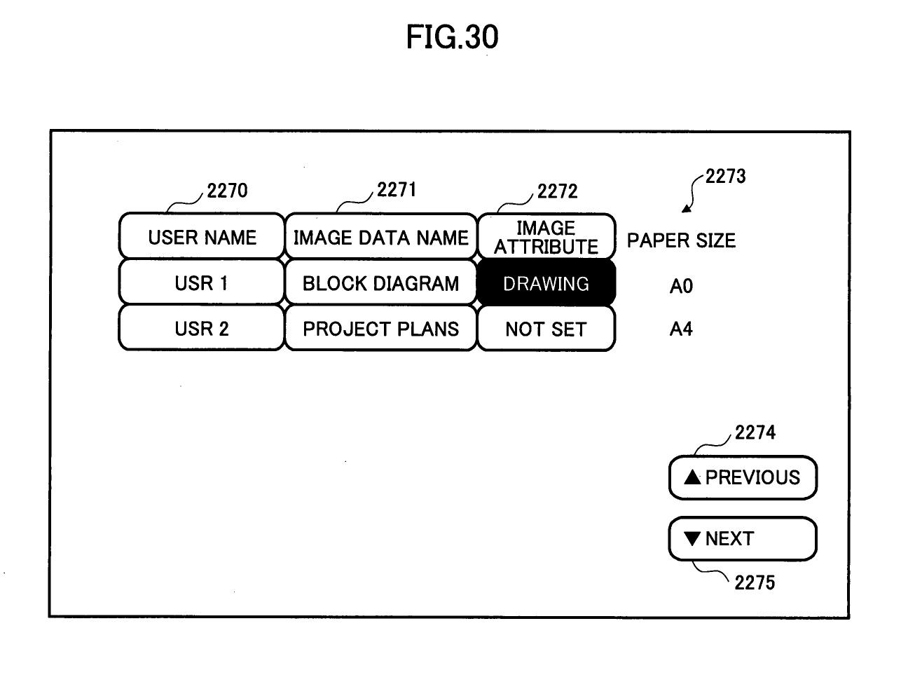

In a case where one of the “not set” buttons in the image attribute column 2272 is selected, a screen for setting image attributes (image attribute setting screen) is displayed as shown in FIG. 29. The image attribute setting screen of FIG. 29 displays, for example, multiple attribute buttons 2280, a cancel button 2281, and a confirm button 2282. In this example, by selecting the attribute button “drawing” and selecting the confirm button 2282, the image attribute is set as “drawing” as shown in the attribute column 2272 shown in FIG. 30.

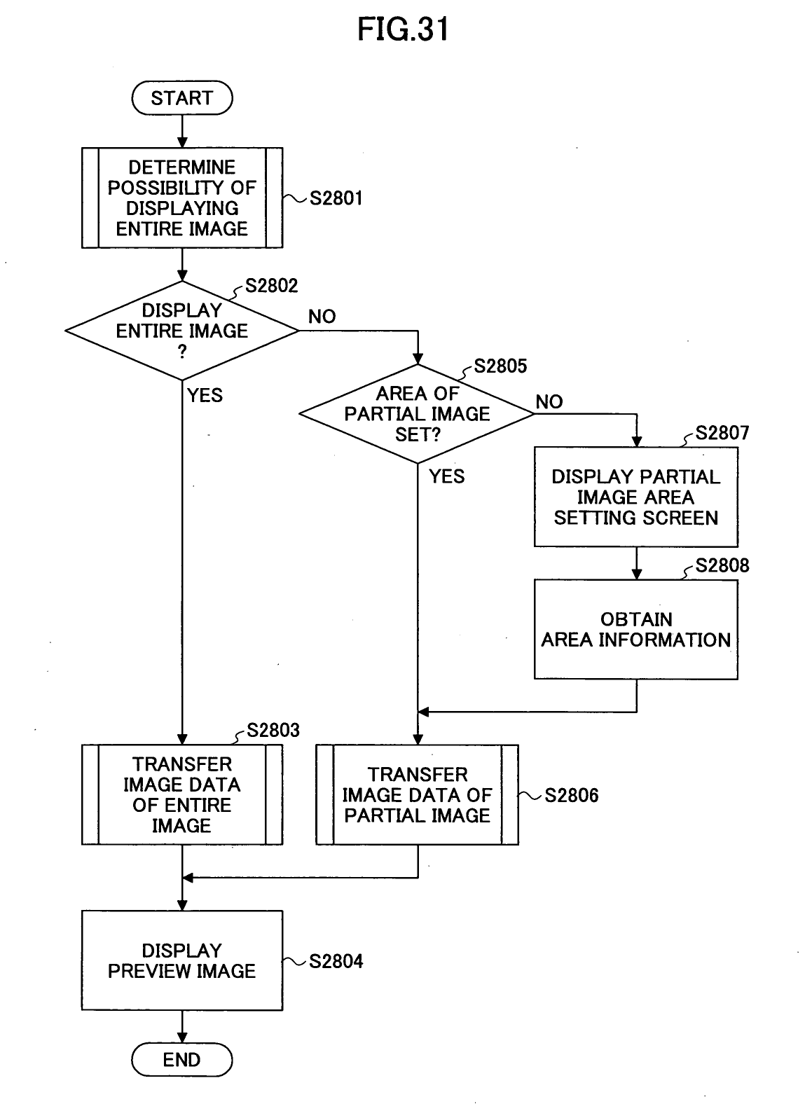

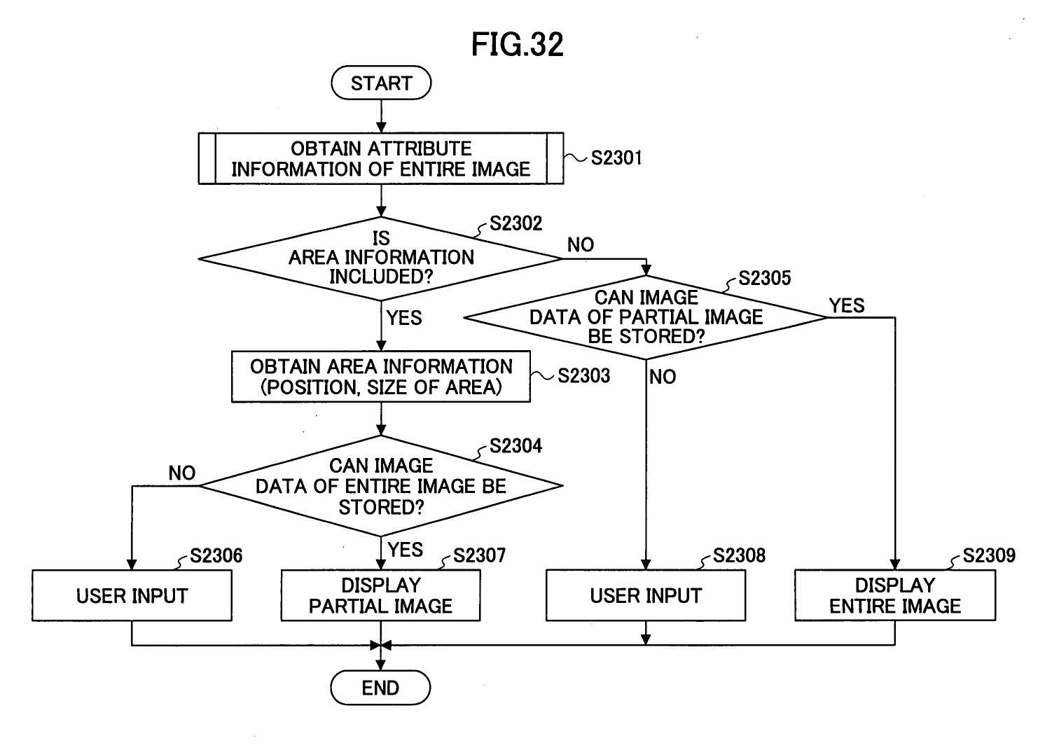

Next, a process for displaying a preview image (preview display process) is described with reference to FIG. 31. FIG. 31 is a flowchart showing a process for displaying a preview image according to an embodiment of the present invention. In Step S2801, the control portion 2110 determines whether it is possible to display a preview image of an entire image (this step is described in detail below with reference to the flowchart shown in FIG. 32).

Then, in Step S2802, the control portion 2110 determines whether to display a preview of an entire image. In this step, the control portion 2110 determines that a preview image of an entire image is to be displayed when the size of the area set by the user is greater than the entire image. In a case where the control portion 2110 determines the display of the entire image (Yes in Step S2802), the control portion 2110 instructs the image process portion 2111 to transfer image data (Step S2803). In Step S2804, a preview image of the entire image is displayed by performing a display process.

Meanwhile, in a case where the control portion 2110 determines not to display a preview image of an entire image in Step S2802, the control portion 2110 determines whether an area of a partial image of the entire image is set (Step S2805). In a case where the area of the partial image is set (Yes in Step S2805), the control portion 2110 instructs the image process part 2111 to transfer the image data of the partial image corresponding to the set area (Step S2806). Then, in Step S2804, a preview image of the partial image is displayed.

Meanwhile, in a case where the control portion 2110 determines that the area of the partial image is not set (No in Step S2805), the control portion 2110 instructs the display management portion 2114 to display a screen for setting the area of the partial image of the entire image (partial image area setting screen) (Step S2807). Then, in Step S2808, the control portion 2110 obtains information (data) for setting the area of the partial image (i.e. partial image data), for example, in accordance with the area set by the user. In Step S2806, the image process portion 2111 transfers the partial image data to the display management portion 2114. Then, in Step S2806, the display management portion 2114 displays the preview image of the partial image.

Next, the above-described Step S2801 is described in further detail with reference to the flowchart shown in FIG. 32. In Step S2301, the control portion 2110 obtains attribute information of the image data of the entire image (original image). In Step S2302, the control portion 2110 determines whether the attribute information of the original image data includes area information for a partial image (e.g. position, size of area) of the entire image (original image). The attribute information may include, for example, the type of image data (e.g. image data for drawings, project plans, etc.). The attribute information may be, for example, set in correspondence with the image data. Furthermore, the attribute information may be set in correspondence with a predetermined area of a partial image. Accordingly, in a case where the attribute information of the image data is set with (included with) area information for a partial image (e.g. position, size of area) of the entire image (original image), a preview image is displayed in accordance with the area information.

In a case where area information for the partial image is included in the attribute information (Yes in Step S2302), the control portion 2110 obtains the area information of the partial image from the attribute information corresponding to the image data of the original image (Step S2303). Next, the control portion 2110 determines whether the image data corresponding to the area information for displaying the partial image has a size that can be stored in the preview image display memory space 2229 (Step S2304). In a case where the control portion 2110 determines that the image data corresponding to the area information of the partial image has a size that can be stored in the preview image display memory space 2229 (Yes in Step S2304), the control portion 2110 determines that the partial image be displayed. In a case where the control portion 2110 determines that the image data has a size that cannot be stored in the preview image display memory space 2229 (No in Step S2304), the control portion 2110 prompts (requests) the user to set the area of the partial image (Step S2306).

Meanwhile, in a case where the control portion 2110 determines that the area information of the image data is not set with (included with) area information for a partial image (e.g. position, size of area) of the entire image (original image) (No in Step S2302), the control portion 2110 determines whether the image data of the original image has a size that can be stored in the preview image display memory space 2229 (Step S2305). In a case where the control portion 2110 determines that the image data of the original image has a size that can be stored in the preview image display memory space 2229, the control portion 2110 determines that the original image be entirely displayed (display the entire image) (Step S2309). In a case where the control portion 2110 determines that the image data of the original image has a size that cannot be stored in the preview image display memory space 2229, the control portion 2110 prompts (requests) the user to set the area of the original image (Step S2308).

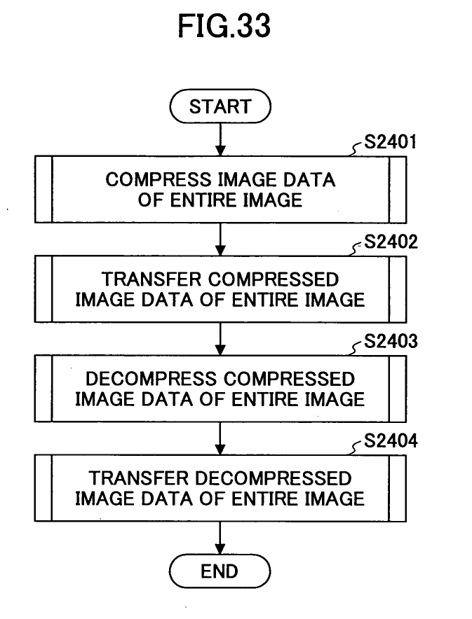

Next, Step S2803 of FIG. 31 is described with reference to the flowchart shown in FIG. 33. In Step S2401, the image process portion 2111 compresses the data of the original image (entire image). In Step S2402, the image process portion 2111 transfers the compressed image data of the original image (entire image) to the preview image storage portion 2115.

Next, the display management portion 2114 decompresses the compressed image data of the original image (entire image) (Step S2403). Then, the display management portion 2114 transfers the decompressed image data of the original image (entire image) to the preview image display memory space 2129 by using, for example, DMA transfer (Step S2404).

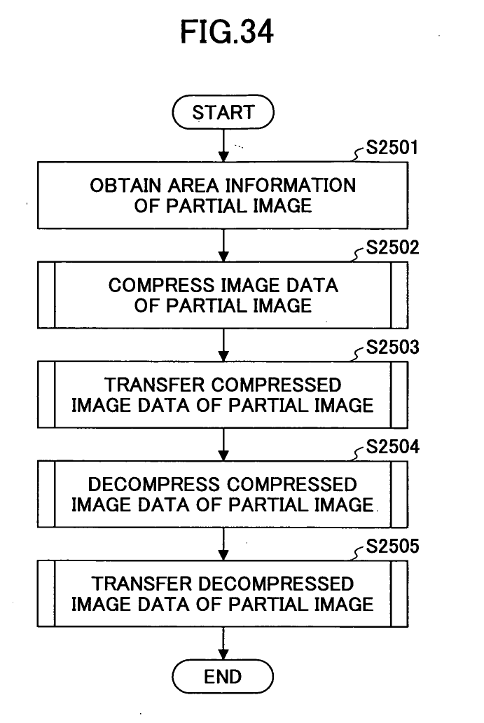

Next, Step S2806 of FIG. 31 is described with reference to the flowchart shown in FIG. 34. In Step S2501, the control portion 2110 obtains area information of the partial image of the original image. In Step S2502, the image process part 2110 compresses the image data of the partial image. In Step S2503, the image process portion 2111 transfers the compressed image data of the partial image to the preview image storage portion 2115.

Next, the display management portion 2114 decompresses the compressed image data of the partial image (Step S2504). Then, the display management portion 2114 transfers the decompressed image data of the partial image to the preview image display memory space 2129 by using, for example, DMA transfer (Step S2505).

Further, the present invention is not limited to these embodiments, but variations and modifications may be made without departing from the scope of the present invention.

The present application is based on Japanese Priority Application Nos. 2004-290325 and 2004-292810 filed on Oct. 1, 2004 and Oct. 5, 2004, respectively, with the Japanese Patent Office, the entire contents of which are hereby incorporated by reference.

What is claimed is:

1. An image processing apparatus comprising:
a display part;
an image data storage part for storing original image data corresponding to an original image;
a thumbnail image data generating part for generating thumbnail image data based on the original image data of the original image;
a transferring part for transferring the generated thumbnail image data to the display part; and
a determining part for determining whether the thumbnail image data is to be transferred to the display part;
wherein when the determining part determines that the thumbnail image data is not to be transferred to the display part, the display part withholds displaying an original thumbnail image corresponding to the generated thumbnail image data and displays a replacement thumbnail image indicating that the display of the original thumbnail image is withheld.

2. The image processing apparatus as claimed in claim 1, wherein the display part displays the original thumbnail image when the withholding of the display of the original thumbnail image is cancelled.

3. The image processing apparatus as claimed in claim 2, wherein the withholding of the display of the original thumbnail image is cancelled when the user selects the replacement thumbnail image.

4. The image processing apparatus as claimed in 1, wherein the original thumbnail image is a partial image of the original image.

5. The image processing apparatus as claimed in claim 4, wherein the area of the partial image is set by the user.

6. The image processing apparatus as claimed in claim 1, wherein the determining part determines the transfer of the thumbnail image data according to the data size of the original image data of the original image.

7. A thumbnail display method comprising the steps of:
a) determining whether to display an entire image of an original image as a thumbnail image;
b) withholding displaying the entire image of the original image as the thumbnail image when determining not to display the entire image of the original image in step a); and
c) displaying a replacement thumbnail image indicating that the display of the entire image of the original image is withheld.

8. The thumbnail display method as claimed in claim 7, further comprising the step of:
d) canceling the withholding of the display of the entire image of the original image as the thumbnail image.

9. The thumbnail display method as claimed in claim 8, further comprising the step of:
e) displaying a partial image of the original image as the thumbnail image in a case where the withholding of the display of the entire image of the original image is canceled in step d).

10. The thumbnail display method as claimed in claim 9, further comprising the step of:
setting the area of the partial image of the original image.

11. The thumbnail display method as claimed in claim 7, wherein the determination of step a) is based on the data size of the original image.

12. A recording medium on which a program for causing an image processing apparatus to execute a thumbnail display method is recorded, the thumbnail display method comprising the steps of:
a) determining whether to display an entire image of an original image as a thumbnail image;
b) withholding displaying the entire image of the original image as the thumbnail image when determining not to display the entire image of the original image in step a); and
c) displaying a replacement thumbnail image indicating that the display of the entire image of the original image is withheld.

13. An image processing apparatus for displaying a preview image of an original image, the image processing apparatus comprising:
a preview area setting part for setting the area for displaying the preview image; and
a display part for displaying the preview image in correspondence with the area set by the preview area setting part.

14. The image processing apparatus as claimed in claim 13, further comprising:
an original image data storage part for storing original image data corresponding to the original image; and
an attribute registering part for registering the area set by the preview area setting part in correspondence with an attribute that is set for the original image data of the original image.

15. The image processing apparatus as claimed in claim 14, further comprising:
an attribute setting part for setting the attribute for the original image data of the original image.

16. The image processing apparatus as claimed in claim 14, wherein the attribute includes the size of the original image.

17. The image processing apparatus as claimed in claim 13, wherein the preview area setting part is operable to set the entire area of the original image as the area of the preview image.

18. The image processing apparatus as claimed in claim 13, further comprising:
a determining part for requesting the user to set the area for displaying the preview image in a case where the original image data of the original image has a data size that cannot be stored in the original image data storage part.

19. A preview display method for displaying a preview image of an original image, the method comprising the steps of:
a) setting the area for displaying the preview image; and
b) displaying the preview image in correspondence with the area set in step a).

20. The preview display method as claimed in claim 19, further comprising the steps of:
c) storing original image data corresponding to the original image; and
d) registering the area set in step a) in correspondence with an attribute that is set for the original image data of the original image.

21. The preview display method as claimed in claim 20, further comprising the step of:
e) setting the attribute for the original image data of the original image.

22. The preview display method as claimed in claim 20, wherein the attribute includes the size of the original image.

23. The preview display method as claimed in claim 20, wherein the entire area of the original image can be set as the area of the preview image in step a).

24. The preview display method as claimed in claim 20, further comprising the step of:
requesting the user to set the area for displaying the preview image in a case where the original image data of the original image has a data size that is greater than a predetermined data size.

25. A recording medium on which a program for causing an image processing apparatus to execute a preview display method is recorded, the preview display method comprising the steps of:
a) setting the area for displaying the preview image; and
b) displaying the preview image in correspondence with the area set in step a).
